(19) United States
(12) Patent Application Publication
(10) Pub. No.: US 2024/0052648 A1
(43) Pub. Date: Feb. 15, 2024

(54) SCAFFOLDING DEVICE AND METHOD OF ASSEMBLING SCAFFOLDING DEVICE

(71) Applicant: Dai ONO, Tokyo (JP)

(72) Inventor: Dai ONO, Tokyo (JP)

(21) Appl. No.: 18/267,613

(22) PCT Filed: Mar. 31, 2022
(86) PCT No.: PCT/JP2022/016633

§ 371 Date: Jun. 15, 2023

(30) Foreign Application Priority Data
Sep. 22, 2021 (JP) 2021-154863

(51) Int. Cl. E04G 3/22; E04G 7/02; E04G 5/06; E04G 5/00

(52) U.S. Cl. CPC E04G 3/22; E04G 7/02; E04G 5/06; E04G 5/007

(57) ABSTRACT

A means for solving the problem is characterized in including: a frame body including a pair of longitudinal beams, a pair of lateral beams, and four coupling members disposed between respective end portions of the longitudinal beams and respective end portions of the lateral beams so as to rotatably connect the longitudinal beams and the lateral beams on the same plane, two or more intermediate beams bridged between the longitudinal beams at a predetermined interval; and scaffolding boards bridged between the longitudinal beams and supported by at least one of the intermediate beams, the number of the scaffolding boards being larger than the installing number of the intermediate beams by one.

### TECHNICAL FIELD

The present invention relates to a scaffolding device and a method of assembling a scaffolding device.

### BACKGROUND ART

As a conventional scaffolding device, for example, as disclosed in JP 5820848 B, there is a scaffolding device that is suspended from a building structure or a construction structure and is used in construction or maintenance work of the building structure or the construction structure.

Specifically, a scaffolding device illustrated in JP 5820848 B includes: a frame body including a pair of longitudinal beams, a pair of lateral beams, and four coupling members disposed between respective end portions of the longitudinal beams and respective end portions of the lateral beams and rotatably connecting the longitudinal beams and the lateral beams in the horizontal direction; and a scaffolding board bridged between a central beam bridged between centers of the pair of lateral beams and each of the longitudinal beams.

In addition, in the scaffolding device of JP 5820848 B, each proximal end of the longitudinal beam for expansion is connected in a horizontally rotatable manner to each of two existing coupling members disposed on the depth-side in the depth direction of the existing frame body and adjacent to each other, and the coupling member for expansion is attached to the distal end of each longitudinal beam for expansion in a state where the longitudinal beam for expansion is pulled toward the lateral beam side by using the existing coupling member as a fulcrum, and after the lateral beam for expansion is bridged between the adjacent existing coupling members, the longitudinal beam for expansion is horizontally rotated so as to be disposed parallel to each other, whereby the frame body for expansion can be continuously provided to the existing frame body. Then, by bridging a central beam between existing lateral beams facing each other in the depth direction of the frame body for expansion and the lateral beams for expansion and bridging scaffolding boards between the central beam and each of the longitudinal beams for expansion, the scaffolding device of JP 5820848 B can expand the floor board area.

### CITATION LIST

### Patent Literature

Patent Literature 1: JP 5820848 B

### SUMMARY OF INVENTION

### Technical Problem

However, in the conventional scaffolding device, since the components constituting the scaffolding device are large, or the scaffolding device is formed of a material having a large mass per unit volume in order to secure a load (hereinafter, referred to as “loading capacity”) that can be loaded on the scaffolding device, the weight of the components constituting the scaffolding device becomes heavy, and the assembly work of the scaffolding device is heavy work for the worker.

Therefore, an object of the present invention is to provide a scaffolding device and method of assembling a scaffolding device that achieve weight reduction of components constituting the scaffolding device and facilitate assembly work.

### Solution to Problem

In order to achieve the above object, a scaffolding device of the present invention includes: a frame body including a pair of longitudinal beams, a pair of lateral beams, and four coupling members disposed between respective end portions of the longitudinal beams and respective end portions of the lateral beams and rotatably connecting the longitudinal beams and the lateral beams on the same plane; two or more intermediate beams bridged between the longitudinal beams at a predetermined interval; and scaffolding boards bridged between the longitudinal beams and supported by at least one of the intermediate beams, the number of the scaffolding boards being larger than the installing number of the intermediate beams by one. With this configuration, since the number of scaffolding boards to be installed in the frame body can be at least three or more, the weight per scaffolding board can be reduced as compared with the case where the number of scaffolding boards to be installed in the frame body is two or less.

### Advantageous Effects of Invention

With the scaffolding device and the method of assembling a scaffolding device of the present invention, since the components constituting the scaffolding device can be reduced in weight, the assembly work of the scaffolding device is facilitated, and the time required for assembling the scaffolding device can be shortened.

### BRIEF DESCRIPTION OF DRAWINGS

FIG. 1 is a perspective view of a scaffolding device according to a first embodiment.

FIG. 2 is a perspective view of a longitudinal beam and a lateral beam according to the first embodiment.

FIG. 3 is a side view of the longitudinal beam and the lateral beam according to the first embodiment.

FIG. 4 is a cross-sectional view taken along line A-A of FIG. 3.

FIG. 5 is a plan view of the longitudinal beam and the lateral beam according to the first embodiment.

FIG. 6 is a side view of a connecting portion provided at an end portion of a beam body of the longitudinal beam and the lateral beam according to the first embodiment.

FIG. 7 is a front view of the longitudinal beam and the lateral beam according to the first embodiment.

FIG. 8 is a perspective view of a coupling member according to the first embodiment.

FIG. 9 is an enlarged longitudinal sectional view illustrating a connecting portion of a coupling member with respect to each of the longitudinal beam and the lateral beam according to the first embodiment.

FIG. 10(A) is an enlarged exploded perspective view illustrating a connecting portion of a coupling member with respect to each of the longitudinal beam and the lateral beam according to the first embodiment. FIG. 10(B) is an enlarged perspective view illustrating a part of a fixing pin and an anti-rotation pin that connect the longitudinal beam and the lateral beam to the coupling member.

FIG. 11 is an enlarged perspective view illustrating the connecting portion between the coupling member and a chain in the scaffolding device according to the first embodiment.

FIG. 12 is a perspective view of an intermediate beam according to the first embodiment.

FIG. 13 is a longitudinal cross-sectional view of the intermediate beam according to the first embodiment.

FIG. 14 is a partially enlarged side view of the intermediate beam according to the first embodiment.

FIG. 15 is an exploded perspective view of the longitudinal beam and the intermediate beam according to the first embodiment.

FIG. 16 is a longitudinal cross-sectional view of the longitudinal beam and the lateral beam in a state in which scaffolding boards are bridged in the scaffolding device according to the first embodiment.

FIG. 17 is a longitudinal sectional view of the longitudinal beam in a state where a bracket is connected.

FIG. 18 is a side view of the bracket.

FIG. 19 is a view explaining a method of assembling the scaffolding device according to the first embodiment, and is a perspective view illustrating a state in which the scaffolding device assembled on the ground is suspended by a building structure or a construction structure.

FIG. 20 is a view explaining the method of assembling the scaffolding device according to the first embodiment, and is a perspective view illustrating a step of connecting longitudinal beams for expansion to an existing frame body of the scaffolding device assembled on the ground.

FIG. 21 is a view explaining the method of assembling the scaffolding device according to the first embodiment, and is a perspective view illustrating a step of bridging a first intermediate beam for expansion between longitudinal beams for expansion.

FIG. 22 is a view explaining the method of assembling the scaffolding device according to the first embodiment, and is a perspective view illustrating a step of bridging a first scaffolding board for expansion between the longitudinal beams for expansion.

FIG. 23 is a view explaining the method of assembling the scaffolding device according to the first embodiment, and is a perspective view illustrating a step of bridging a lateral beam for expansion between coupling members for expansion.

FIG. 24(A) is a perspective view illustrating a step of connecting one end of the lateral beam for expansion to one coupling member for expansion by rotating the one coupling member for expansion inward. FIG. 24(B) is a perspective view illustrating a step of connecting the other end of the lateral beam for expansion to the other coupling member for expansion by rotating the one coupling member for expansion outward.

FIG. 25 is a view explaining the method of assembling the scaffolding device according to the first embodiment, and is a perspective view illustrating a state in which the scaffolding unit for expansion is connected to an existing scaffolding unit.

FIG. 26 is a plan view of a frame body in a scaffolding device according to a second embodiment.

FIG. 27(A) is a plan view of a longitudinal beam of the scaffolding device according to the second embodiment. FIG. 27(B) is a side view of the longitudinal beam of the scaffolding device according to the second embodiment.

FIG. 28(A) is a plan view of a lateral beam of the scaffolding device according to the second embodiment.

FIG. 28(B) is a side view illustrating a contracted state of an expansion/contraction portion of the lateral beam of the scaffolding device according to the second embodiment.

FIG. 28(C) is a side view illustrating an expanded state of the expansion/contraction portion of the lateral beam illustrated in FIG. 28(B).

FIG. 29 is a view explaining a method of assembling the scaffolding device according to the second embodiment, and is a plan view illustrating a state in which a plurality of frame bodies are connected in a folded posture to front-side coupling members.

FIG. 30 is a view explaining a method of assembling the scaffolding device according to the second embodiment, and is a plan view illustrating a state in which a plurality of frame bodies are connected in an unfolded posture to the front-side coupling members.

FIG. 31 is a view explaining the method of assembling the scaffolding device according to the second embodiment, and is a plan view illustrating a state in which the scaffolding unit for expansion is connected to an existing scaffolding unit.

FIG. 32 is a plan view of a frame body in a scaffolding device according to a first modification example of the second embodiment.

FIG. 33 is a view explaining a method of assembling the scaffolding device according to the first modification example of the second embodiment, and is a plan view illustrating a state in which a plurality of frame bodies are connected in a folded posture to the front-side coupling members.

FIG. 34 is a view explaining the method of assembling the scaffolding device according to the first modification example of the second embodiment, and is a plan view illustrating a state in which a plurality of frame bodies are connected in an unfolded posture to the front-side coupling members.

FIG. 35 is a plan view of a frame body in a scaffolding device according to a second modification example of the second embodiment.

FIG. 36 is a view explaining a method of assembling the scaffolding device according to the second modification example of the second embodiment, and is a plan view illustrating a state in which a plurality of frame bodies are connected in a folded posture to the front-side coupling members.

FIG. 37 is a view explaining the method of assembling the scaffolding device according to the second modification example of the second embodiment, and is a plan view illustrating a state in which a plurality of frame bodies are connected in an unfolded posture to the front-side coupling members.

### DESCRIPTION OF EMBODIMENTS

Hereinbelow, the present embodiments are described with reference to the drawings. Identical reference signs denoted through several drawings indicate identical components.

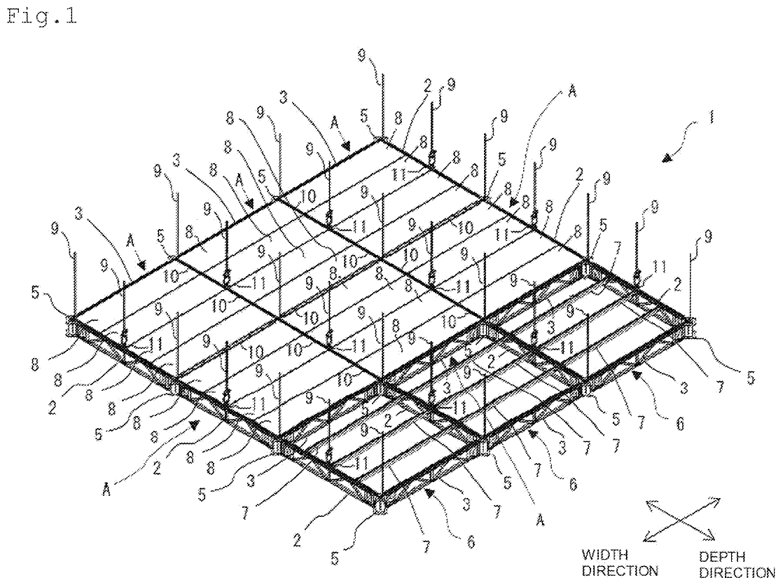

As illustrated in FIG. 1, a scaffolding device 1 according to a first embodiment includes a plurality of scaffolding units A to be disposed while being connected to each other in a depth direction and a width direction.

As illustrated in FIG. 1, each scaffolding unit A includes a frame body 6 including a pair of longitudinal beams 2 and 2, a pair of lateral beams 3 and 3, and four coupling members 5 disposed between respective end portions of the longitudinal beams 2 and respective end portions of the lateral beams 3 to rotatably connect the longitudinal beams 2 and the lateral beams 3 on the same plane; three intermediate beams 7 bridged between the longitudinal beams 2 and 2 at a predetermined interval; and four scaffolding boards 8 bridged between the longitudinal beams 2 and 2 and supported by at least one of the intermediate beams 7. In FIG. 1, the scaffolding boards 8 are not installed in some frame bodies 6 in order to facilitate understanding of the configuration of the scaffolding device 1. Further, the frame bodies 6 and 6 adjacent to each other in the width direction in FIG. 1 share one longitudinal beam 2, and the frame bodies 6 and 6 adjacent to each other in the depth direction in FIG. 1 share one lateral beam 3.

As illustrated in FIG. 1, a chain 9 as a hanging member that hangs the scaffolding unit A is connected to each coupling member 5, and an upper end of the chain 9 is connected to a construction structure or a building structure such as a bridge or a building, so that the scaffolding device 1 is hung on the building structure or the construction structure via the chain 9 to provide a scaffolding to a worker who performs construction or maintenance work of the building structure or the construction structure.

Hereinafter, each portion of the scaffolding unit A constituting the scaffolding device 1 will be described in detail. The frame body 6 of the present embodiment includes the pair of longitudinal beams 2 and 2, the pair of lateral beams 3 and 3, and the four coupling members 5 disposed between respective end portions of the longitudinal beams 2 and 2 and respective end portions of the lateral beams 3 and 3 and rotatably connecting the longitudinal beams 2 and the lateral beams 3 in the horizontal direction, and is configured to be changeable in posture from a folded posture in which the longitudinal beam 2 is pulled toward the lateral beam 3 side to an unfolded posture in which the longitudinal beams 2 and 2 and the lateral beams 3 and 3 are disposed in parallel.

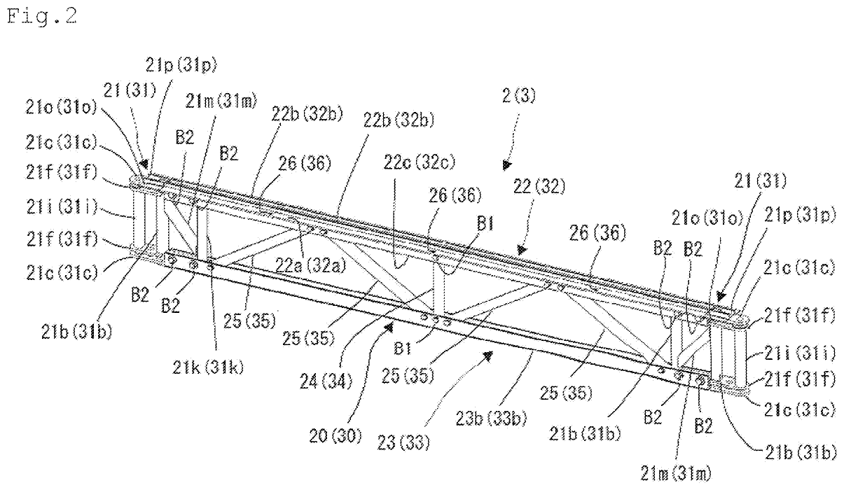

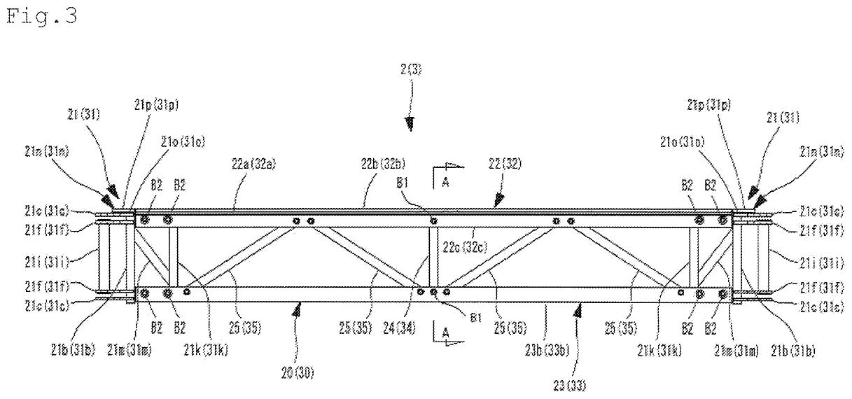

As illustrated in FIGS. 2 and 3, the longitudinal beam 2 and the lateral beam 3 of the present embodiment each include a beam body 20 (30) made of aluminum, and connecting portions 21 (31) made of steel which are respectively detachably connected to both ends of the beam body 20 (30) in the longitudinal direction and can connect the beam body 20 (30) to the coupling member 5 described later.

As described above, since the connecting portions 21 (31) of the present embodiment are each a portion to be connected with the coupling member 5 and are a portion to which a large shear load acts when the scaffolding device 1 is used, the connecting portions are formed using steel, which is a material having higher rigidity than rigidity of the beam body 20 (30), as a material. On the other hand, when comparing with the connecting portions 21 (31), the load acting on the beam body 20 (30) is smaller than that acting on the connecting portions 21 (31) when the scaffolding device 1 is used, and thus the beam body 20 (30) is made of aluminum, which is lower in rigidity than steel but smaller in mass per unit volume and lighter in weight.

Therefore, the longitudinal beams 2 and the lateral beams 3 of the present embodiment are lighter than a case where both the beam body 20 (30) and the connecting portions 21 (31) are made of steel without causing a decrease in the loading capacity of the scaffolding device 1.

Note that the beam body 20 (30) is made of steel, and the connecting portions 21 (31) are made of aluminum as an example. With the beam body 20 (30) formed of a material having a mass per unit volume smaller than that of the connecting portions 21 (31) and the connecting portions 21 (31) formed of a material having rigidity higher than that of the beam body 20 (30), it is possible to reduce the weight of the longitudinal beam 2 and the lateral beam 3 without reducing the loading capacity of the scaffolding device 1. However, the beam body 20 (30) and the connecting portions 21 (31) may be formed of the same material.

In addition, as illustrated in FIGS. 2 and 3, the beam body 20 (30) is a beam member having a truss structure including an upper chord 22 (32) and a lower chord 23 (33) disposed in parallel to vertically face each other, a strut 24 (34) vertically bridged between the upper chord 22 (32) and the lower chord 23 (33) to connect the upper chord 22 (32) and the lower chord 23 (33), and a plurality of diagonal bracings 25 (35) diagonally bridged between the upper chord 22 (32) and the lower chord 23 (33).

In the present embodiment, the beam body 20 (30) has a truss structure in which the upper chord 22 (32) and the lower chord 23 (33) are connected by the diagonal bracings 25 (35) in order to secure strength, but the structure of the beam body 20 (30) is not limited to the truss structure as long as necessary strength is secured.

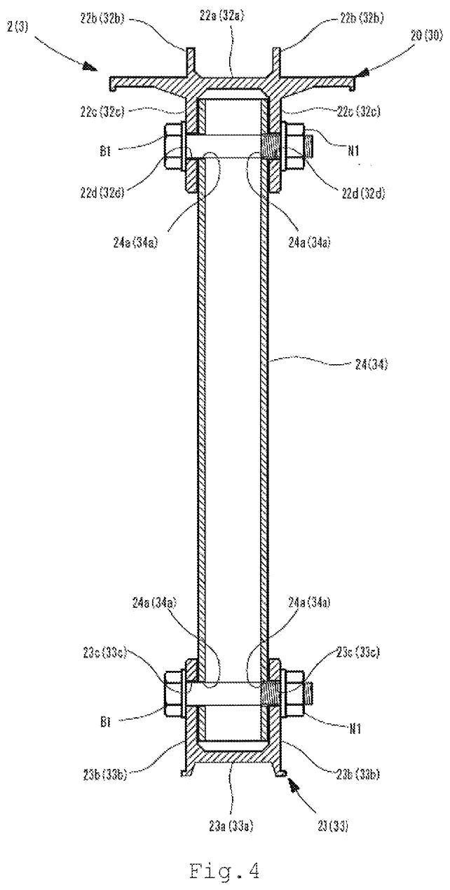

In addition, as illustrated in FIG. 4, the upper chord 22 (32) includes: a scaffolding board support portion 22a (32a) in a flat plate shape and extending along the longitudinal direction of the beam body 20 (30); a pair of positioning pieces 22b and 22b (32b and 32b) that stand upward from the upper surface of the scaffolding board support portion 22a (32a) and are provided along the longitudinal direction of the beam body 20 (30) to face each other with an interval; and a pair of holding pieces 22c and 22c (32c and 32c) that stand downward from the lower surface of the scaffolding board support portion 22a (32a) and are provided along the longitudinal direction of the beam body 20 (30) to face each other to sandwich the strut 24 (34) and the diagonal bracings 25 (35).

In addition, as illustrated in FIG. 4, the lower chord 23 (33) is formed in a substantially U-shaped cross section by a bottom piece 23a (33a) and side pieces 23b and 23b (33b and 33b) that vertically stand from both ends of the bottom piece 23a (33a) to face each other to sandwich the strut 24 (34) and the diagonal bracings 25 (35), and is disposed such that the opening side faces the upper chord 22 (32) side.

Holes 22d and 22d (32d and 32d) facing each other are provided in the holding pieces 22c and 22c (32c and 32c) of the upper chord 22 (32) at a predetermined interval along the longitudinal direction of the beam body 20 (30). Holes 23c and 23c (33c and 33c) facing each other are provided in the side pieces 23b and 23b (33b and 33b) of the lower chord 23 (33) at a predetermined interval along the longitudinal direction of the beam body 20 (30).

Then, as illustrated in FIG. 4, the upper end and the lower end of the strut 24 (34) are respectively disposed between the holding pieces 22c and 22c (32c and 32c) of the upper chord 22 (32) and between the side pieces 23b and 23b (33b and 33b) of the lower chord 23 (33), holes 24a (34a) provided at the upper end and the lower end of the strut 24 (34) are respectively allowed to face the holes 22d (32d) provided in the holding pieces 22c and 22c (32c and 32c) and the holes 23c and 23c (33c and 33c) provided in the side pieces 23b and 23b (33b, 33b) of the lower chord 23 (33), a bolt B1 is inserted into each of the facing holes, and a nut N1 is screwed and tightened to the bolt B1 from the opposite side, and thus the strut 24 (34) is connected between the upper chord 22 (32) and the lower chord 23 (33) by bolt-nut connection.

Although not illustrated, holes are also provided at the upper end and the lower end of the diagonal bracing 25 (35), and the diagonal bracing 25 (35) is connected between the upper chord 22 (32) and the lower chord 23 (33) by the bolt B1 and the nut N1 in the same procedure as the strut 24 (34).

Therefore, in the present embodiment, the upper chord 22 (32), the lower chord 23 (33), the strut 24 (34), and the diagonal bracing 25 (35) are connected to each other in a detachable manner using the bolt B1 and the nut N1. Therefore, even if any of the components constituting the beam body 20 (30) is damaged or deformed due to aging deterioration or a load, it is only necessary to disassemble so as to replace the damaged or deformed component, which facilitates maintenance.

Further, as described above, the beam body 20 (30) of the present embodiment is made of aluminum, but welding of aluminum takes time and effort, and it is very costly to connect the upper chord 22 (32), the lower chord 23 (33), the strut 24 (34), and the diagonal bracing 25 (35) by welding. In contrast, in the present embodiment, the beam body 20 (30) can be made into a truss structure while avoiding welding, because the upper chord 22 (32), the lower chord 23 (33), the strut 24 (34), and the diagonal bracing 25 (35) are connected using the bolt B1 and the nut N1.

The means of connecting the upper chord 22 (32), the lower chord 23 (33), the strut 24 (34), and the diagonal bracing 25 (35) in a detachable manner is not limited to the connecting means using the bolt B1 and the nut N1. Although welding costs would be high if the beam body 20 (30) is made of aluminum, the components constituting the beam body 20 (30) may be connected by welding.

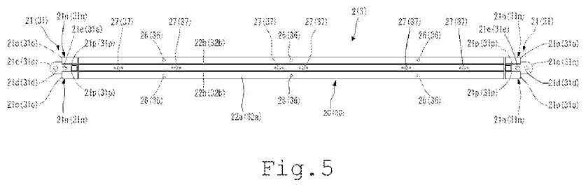

In addition, as illustrated in FIG. 5, three hooking holes 26 (36) are disposed at predetermined intervals along the longitudinal direction of the beam body 20 (30) in portions outside the positioning pieces 22b and 22b (32b and 32b) in the width direction in the scaffolding board support portion 22a (32a) respectively, and the intermediate beam 7 can be connected to the beam body 20 (30) by inserting pin bodies 71d of a hooking portion 71 provided at an end portion of the intermediate beam 7 described later into each of the hooking holes 26 (36). The number of the hooking holes 26 (36) is not limited to three, and the number of the hooking holes 26 (36) may be the same as the number of the intermediate beams 7 bridging between the longitudinal beams 2 and 2.

Further, as illustrated in FIG. 5, six screw holes 27 (37) are provided side by side along the longitudinal direction of the beam body 20 (30) between the positioning pieces 22b and 22b (32b and 32b) in the scaffolding board support portion 22a (32a) of the upper chord 22 (32). However, the number of screw holes 27 (37) is not limited to six, and any number may be provided.

In the present embodiment, as illustrated in FIG. 5, the six screw holes 27 (37) are disposed two by two at intervals on each of the left side, the center, and the right side in the drawing, and the interval between the two screw holes 27 and 27 (37 and 37) disposed at the center is narrower than the interval between the two screw holes 27 and 27 (37 and 37) disposed on the left side and the right side, respectively. The screw hole 27 (37) is formed by a nut 27c (37c) described later.

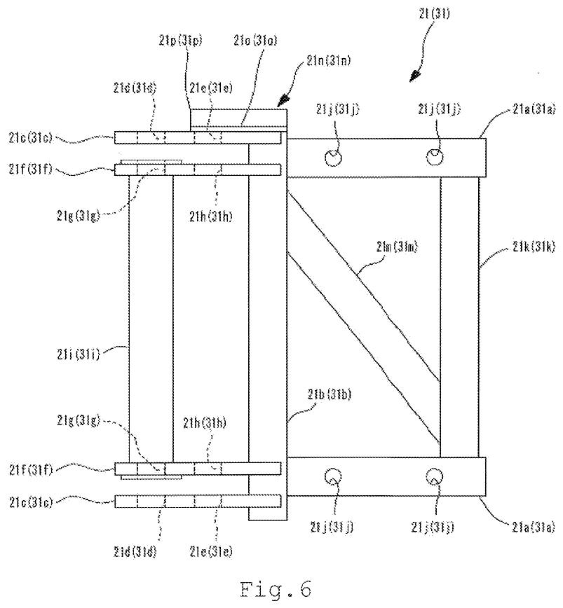

Referring back to the previous drawings, as illustrated in FIG. 6, the connecting portion 21 (31) of the present embodiment includes a pair of upper and lower fixing members 21a and 21a (31a and 31a) having a quadrangular tubular cross section, a connecting member 21b (31b) having a quadrangular tubular cross section that is bridged and connected between one ends of the pair of fixing members 21a and 21a (31a and 31a), and a pair of upper and lower connecting pieces 21c and 21c (31c and 31c) in a flat plate shape respectively provided on the upper end side and the lower end side of the connecting member 21b (31b) and protruding along the axial direction of the fixing member 21a (31a).

Then, the pair of upper and lower fixing members 21a and 21a (31a and 31a) of the connecting portion 21 (31) are inserted from the end portion of the beam body 20 (30) between the pair of the holding pieces 22c and 22c (32 and 32c) of the upper chord 22 (32) and between the pair of side pieces 23b and 23b (33b and 33b) of the lower chord 23 (33), respectively, and in a state where two holes 21j (31j) provided side by side in the pair of fixing members 21a and 21a (31a and 31a) and two holes (not illustrated) provided side by side in the holding piece 22c and the side piece 23b (33b) of the beam body 20 (30), respectively, are allowed to face each other, a bolt B2 is inserted into these holes, and a nut (not illustrated) is screwed and tightened to the bolt B2 from the opposite side, so that the connecting portion 21 (31) is detachably connected to each end portion of the beam body 20 (30) as illustrated in FIGS. 2 and 3.

A method of connecting the connecting portion 21 (31) to the beam body 20 (30) is not particularly limited as long as the connecting portion 21 (31) and the beam body 20 (30) can be disassembled.

As illustrated in FIG. 6, each connecting piece 21c (31c) is provided with a first attachment hole 21d (31d) disposed on the distal end side and a second attachment hole 21e (31e) disposed on the proximal end side. The first attachment hole 21d (31d) and the second attachment hole 21e (31e) are provided side by side along the longitudinal direction of the beam body 20 (30) with respect to each connecting piece 21c (31).

As illustrated in FIG. 6, a pair of upper and lower supporting pieces 21f and 21f (31f and 31f) in a flat plate shape facing the connecting pieces 21c (31c) are provided between the pair of the connecting pieces 21c and 21c (31c and 31c) of the connecting member 21b (31b). Further, each supporting piece 21f (31f) is provided with a first counter hole 21g (31g) facing the first attachment hole 21d (31d) of the connecting piece 21c (31c) and a second counter hole 21h (31h) facing the second attachment hole 21e (31e) of the connecting piece 21c (31c). Between the pair of supporting pieces 21f and 21f (31f and 31f), a tubular member 21i (31i) having a tubular shape and having a tube end supported by each of the supporting pieces 21f and 21f (31f and 31f) is bridged. Both tube ends of the tubular member 21i (31i) face the first counter hole 21g (31g), and the inside of the tubular member 21i (31i) communicates with the first counter hole 21g (31g).

As illustrated in FIG. 6, the connecting portion 21 (31) of the present embodiment includes a strut 21k (31k) vertically bridged between the pair of fixing members 21a and 21a (31a and 31a), and a diagonal bracing 21m (31m) diagonally bridged between the strut 21k (31k) and the connecting member 21b (31b). Since the connecting portion 21 (31) also has a truss structure including the diagonal bracing 21m (31m), the strength of the connecting portion 21 (31) can be enhanced.

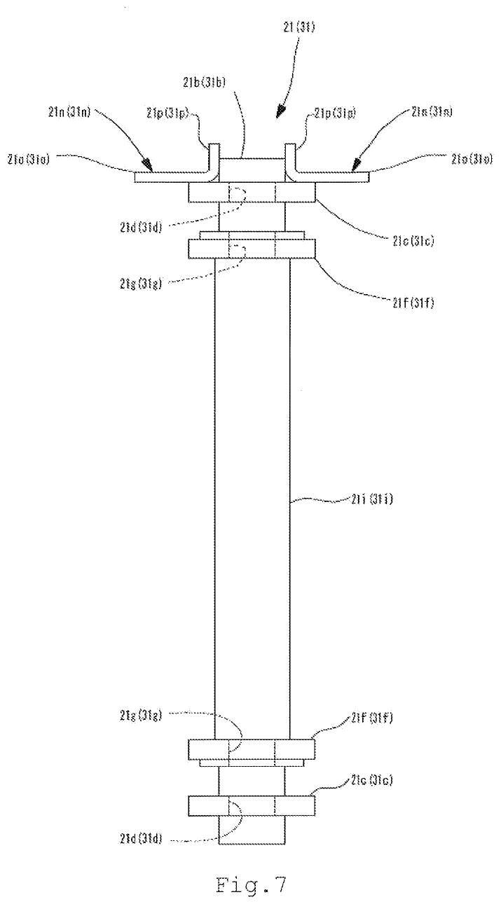

Further, as illustrated in FIGS. 6 and 7, on the upper surface of the upper connecting piece 21c (31c), two L-shaped pieces 21n (31n) having an L-shaped cross section having a bottom portion 21o (31o) extending along the upper surface of the connecting piece 21c (31c) and a vertical portion 21p (31p) vertically protruding from a side end of the bottom portion 21o (31o) are disposed and connected so as to protrude outward from each other with the vertical portions 21p (31p) facing each other in FIG. 7.

As illustrated in FIG. 3, the upper surface of the bottom portion 21o (31o) of each L-shaped piece 21n (31n) is flush with the upper surface of the scaffolding board support portion 22a (32a) of the upper chord 22 (32), and the side surface of the vertical portion 21p (31p) of each L-shaped piece 31n (21n) is flush with the side surface of each positioning piece 22b (32b) as illustrated in FIG. 5.

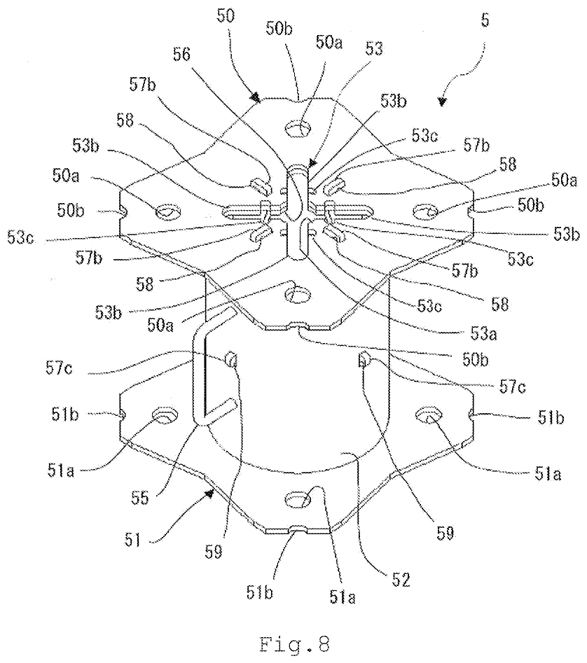

Next, the coupling member 5 of the present embodiment is described in detail. As illustrated in FIG. 8, the coupling member 5 of the present embodiment includes a pair of upper and lower plates 50 and 51 disposed in parallel, and a tubular connecting portion 52 that connects the upper plate 50 and the lower plate 51. In addition, a U-shaped grip portion 55 is provided on the outer periphery of the connecting portion 52, and functions as a handle when carrying the coupling member 5.

As illustrated in FIG. 6, the upper plate 50 and the lower plate 51 are plate members having a shape formed by bringing four isosceles trapezoids into contact with each other around four surfaces of a square shape, and each trapezoidal portion is provided with four insertion holes 50a and 51a disposed at equal intervals on the same circumference so as to face each other, and four anti-rotation grooves 50b and 51b provided at distal ends and at positions facing the insertion holes 50a and 51a when viewed from the center of each of the plates 50 and 51.

Note that the shapes of the upper plate 50 and the lower plate 51 described above are merely examples, and the shapes are not particularly limited, and may be circular or quadrangular. The shape of the connecting portion 52 is not limited to the tubular shape, and may be, for example, a rectangular tubular shape.

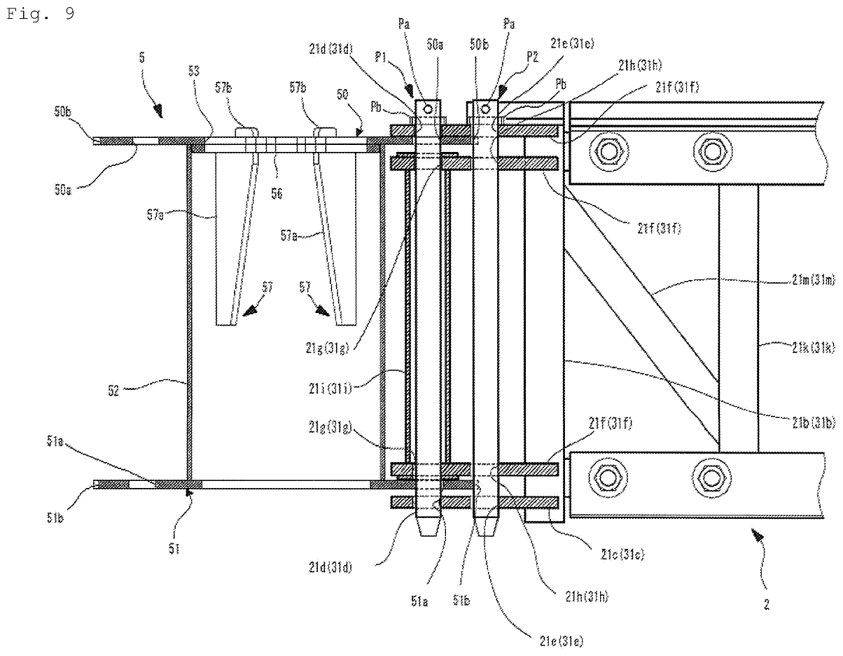

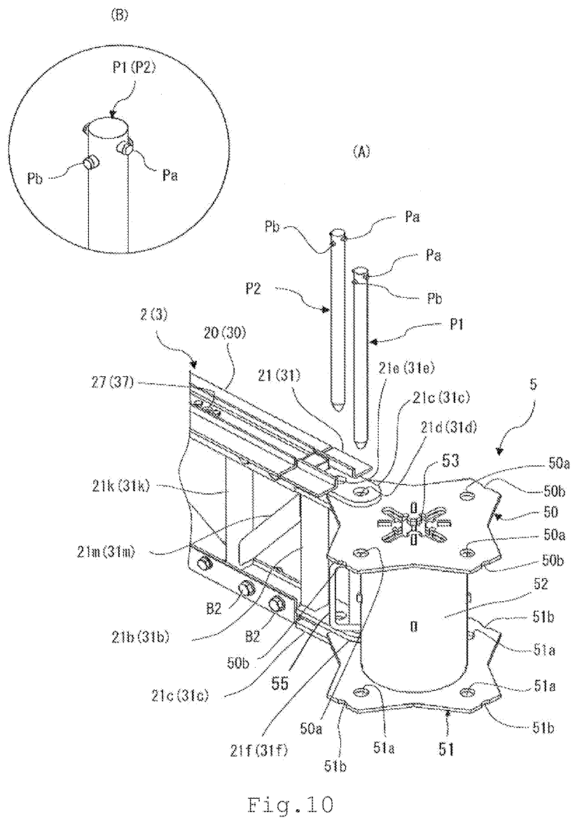

Then, as illustrated in FIGS. 9 and 10(A), the upper plate 50 is inserted between the upper connecting piece 21c (31c) and the upper supporting piece 21f (31f) in the connecting portion 21 (31) of each of the longitudinal beam 2 and the lateral beam 3, the lower plate 51 is inserted between the lower connecting piece 21c (31c) and the lower supporting piece 21f (31f), while the insertion holes 50a and 51a of the plates 50 and 51 and the first attachment holes 21d and 21d (31d, 31d) of the connecting pieces 21c and 21c (31c and 31c) of the connecting portion 21 (31) are respectively allowed to face each other. In this state, by inserting the fixing pin P1 into the first attachment holes 21d and 21d (31d and 31d) and the insertion holes 50a and 51a, the coupling member 5 is connected to the longitudinal beam 2 and the lateral beam 3 so as to be rotatable in the horizontal direction.

The anti-rotation grooves 50b and 51b provided respectively on the outer peripheries of the plates 50 and 51 of the coupling member 5 are provided to face each of the second attachment holes 21e of the connecting portion 21 (31) in a state where the insertion holes 50a and 51a are respectively allowed to face the first attachment holes 21d (31d) of the connecting portion 21 (31).

Therefore, as illustrated in FIG. 9, when the anti-rotation pin P2 is inserted into the second attachment holes 21e and 21e (31e and 31e) in a state where the fixing pin P1 is inserted into the first attachment holes 21d and 21d (31d and 31d) and the insertion holes 50a and 51a, the anti-rotation pin P2 is also inserted into the anti-rotation grooves 50b and 51b. Then, since the coupling member 5 is supported by two shafts with respect to the longitudinal beam 2 and the lateral beam 3, the coupling member 5 is fixed in a non-rotatable state with respect to the longitudinal beam 2 and the lateral beam 3. As described above, when the longitudinal beam 2 and the lateral beam 3 are fixed to the coupling member 5, the longitudinal beam 2 and the lateral beam 3 are connected to the coupling member 5 in a posture orthogonal to each other when the frame body 6 is viewed from above.

In addition, as illustrated in FIG. 10(B), at the upper ends of the fixing pin P1 and the anti-rotation pin P2, two pin-shaped protrusions Pa and Pb that penetrate and protrude through the fixing pin P1 and the anti-rotation pin P2 in the radial direction are provided vertically in line, and these protrusions Pa and Pb are disposed so as to face directions intersecting each other when viewed from the axial direction of the fixing pin P1 and the anti-rotation pin P2. In the present embodiment, these protrusions Pa and Pb are provided so as to penetrate the fixing pin P1 and the anti-rotation pin P2 in the radial direction, but may be formed so as to protrude only in one direction in the radial direction from the fixing pin P1 and the anti-rotation pin P2 without penetrating the fixing pin P1 and the anti-rotation pin P2.

The upper protrusion Pa functions as a handle of the fixing pin P1 and the anti-rotation pin P2, and the lower protrusion Pb functions as a stopper by being caught by edges of the first attachment hole 21d (31d) and the second attachment hole 21e (31) when the fixing pin P1 and the anti-rotation pin P2 are inserted into the first attachment hole 21d (31d) and the second attachment hole 21e (31e).

In addition, in the present embodiment, two holes (not illustrated) penetrating the fixing pin P1 and the anti-rotation pin P2 in the radial direction are opened at the upper end portions of the fixing pin P1 and the anti-rotation pin P2 so as to intersect the fixing pin P1 and the anti-rotation pin P2 when viewed from the axial direction and to be shifted upward and downward, and the upper protrusion Pa and the lower protrusion Pb are inserted and welded to these holes, whereby the upper protrusion Pa and the lower protrusion Pb are connected to the fixing pin P1 and the anti-rotation pin P2. That is, the two holes are provided at twisted positions above and below each of the pins P1 and P2.

In addition, in the present embodiment, the upper protrusion Pa and the lower protrusion Pb are disposed so as to face directions intersecting each other when the fixing pin P1 and the anti-rotation pin P2 are viewed from the axial direction, but may be disposed in parallel in the vertical direction.

However, in a case where the upper protrusion Pa and the lower protrusion Pb are disposed in parallel in the vertical direction, it is necessary to provide a certain distance in the vertical direction between the holes in order to connect the upper protrusion Pa and the lower protrusion Pb to the fixing pin P1 and the anti-rotation pin P2, because drilling cannot be performed unless a thickness between two holes provided on the upper end side of the fixing pin P1 and the anti-rotation pin P2 is secured.

In contrast, as in the present embodiment, when the upper protrusion Pa and the lower protrusion Pb are disposed in the directions intersecting with each other when viewed from the axial direction of the fixing pin P1 and the anti-rotation pin P2, the two holes into which the upper protrusion Pa and the lower protrusion Pb are inserted are disposed at the twisted positions, so that drilling can be performed without difficulty even if the distance between the two holes in the vertical direction is shortened.

Therefore, when the upper protrusion Pa and the lower protrusion Pb are disposed in the directions intersecting with each other when viewed from the axial direction of the fixing pin P1 and the anti-rotation pin P2, the interval between the upper protrusion Pa and the lower protrusion Pb in the vertical direction can be shortened as compared with the case where the upper protrusion Pa and the lower protrusion Pb are disposed in parallel in the vertical direction. Therefore, the fixing pin P1 and the anti-rotation pin P2 are inserted into the first attachment hole 21d (31d) and the second attachment hole 21e (31e), and the protrusion heights of the upper ends of the fixing pin P1 and the anti-rotation pin P2 can be lowered in a state where the lower protrusion Pb is caught on the edges of the first attachment hole 21d (31d) and the second attachment hole 21e (31).

As described above, when the protrusion heights of the upper ends of the fixing pin P1 and the anti-rotation pin P2 are lowered, even if the plate thickness of the scaffolding board 8 to be described later placed on the scaffolding board support portion 22a of the upper chords 22 of the longitudinal beams 2 and 2 is reduced for weight reduction of the scaffolding board 8, as illustrated in FIG. 9, the positions of the upper ends of the fixing pin P1 and the anti-rotation pin P2 can be disposed at the same position as the upper end surface of the scaffolding board 8 or at a position lower than the upper end surface of the scaffolding board 8, so that it is possible to prevent the worker from stumbling over the fixing pin P1 and the anti-rotation pin P2.

There is a slight gap between the fixing pin P1 inserted into the first attachment hole 21d (31d) and the insertion holes 50a and 51a and between the first attachment holes 21d and 21d (31d and 31d) and the insertion holes 50a and 51a in order to smoothly insert the fixing pin P1. Therefore, as illustrated in FIG. 9, the upper end of the fixing pin P1 inserted into the first attachment holes 21d and 21d (31d and 31d) and the insertion holes 50a and 51a is slightly inclined to the right side in the drawing with respect to the lower end in the first attachment holes 21d and 21d (31d and 31d) and the insertion holes 50a and 51a by the gap due to the moment received from the longitudinal beam 2 and the lateral beam 3.

Therefore, although not illustrated, in a state where the coupling member 5 is connected to the longitudinal beam 2 and the lateral beam 3 only by the fixing pin P1, the longitudinal beam 2 and the lateral beam 3 are inclined downward according to the inclination angle of the fixing pin P1.

On the other hand, as illustrated in FIG. 9, there is a slight gap between the anti-rotation pin P2 inserted into the second attachment hole 21e (31e) and the second attachment holes 21e and 21e (31e and 31e), and the lower anti-rotation groove 51b provided in the lower plate 51 is shallower than the upper anti-rotation groove 50b provided in the upper plate 50. Therefore, as illustrated in FIG. 9, the upper end of the anti-rotation pin P2 inserted into the second attachment holes 21e and 21e (31e, 31e) tends to incline to the right side in FIG. 9 with respect to the lower end in the second attachment holes 21e and 21e (31e, 31e) due to the moment received from the longitudinal beam 2 and the lateral beam 3, but the lower end is laterally supported by the lower plate 51 to suppress the inclination.

That is, in the present embodiment, since the lower end of the anti-rotation pin P2 is laterally supported by the lower plate 51 even when moment is received from the longitudinal beam 2 and the lateral beam 3, the longitudinal beam 2 and the lateral beam 3 can be horizontally disposed.

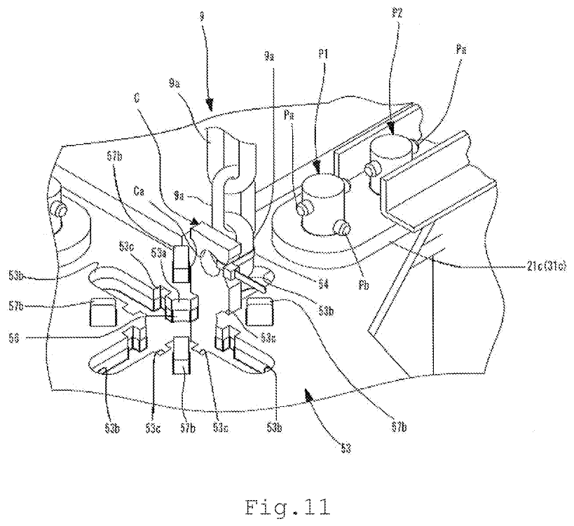

Referring back to the previous drawings, as illustrated in FIGS. 8 and 11, a chain fixing hole 53 to which the lower end of the chain 9 can be connected is provided at the center of the upper plate 50. Specifically, as illustrated in FIG. 8, the chain fixing hole 53 of the present embodiment is formed in a cross shape having a central hole portion 53a that allows insertion of the chain 9 and four protruding hole portions 53b extending in the radial direction from the central hole portion 53a toward each insertion hole 50a side. Further, the chain fixing hole 53 has a cutout groove 53c crossing the extending direction of each protruding hole portion 53b.

Therefore, as illustrated in FIG. 11, when the chain 9 is inserted into the central hole portion 53a, then a ring 9a constituting the chain 9 is moved in the lateral direction along the protruding hole portion 53b, and inserted into the protruding hole portion 53b that is wider than the thickness of the ring 9a and narrower than the lateral width, a ring 9a below the ring 9a is positioned in a direction orthogonal to the protruding hole portion 53b, and thus the chain 9 does not come off from the protruding hole portion 53b of the upper plate 50.

Further, as illustrated in FIG. 11, a chain fixing plate C is inserted into the cutout groove 53c in a state where the chain 9 is inserted into the protruding hole portion 53b, a restraint band 54 is passed through a hole Ca provided on the upper end side of the chain fixing plate C and the ring 9a of the chain 9, and the chain fixing plate C and the chain 9 are fixed by the restraint band 54, whereby the movement of the chain 9 in the lateral direction is also regulated.

In the present embodiment, the lower end of the chain 9 is connected to the chain fixing hole 53 of the coupling member 5 in this manner, but the connection method described above is an example, and the chain 9 may be connected to the coupling member 5 by another method. The hanging member that suspends the scaffolding unit A may not be the chain 9.

As illustrated in FIGS. 8 and 9, a reinforcing plate 56 is fixed to the lower surface of the upper plate 50 by four rib plates 57 connected to the upper plate 50 and the connecting portion 52. This reinforces the upper plate 50 of the coupling member 5 lifted by the chain 9.

Specifically, as illustrated in FIG. 8, a first fitting hole 58 is each formed between the adjacent protruding hole portions 53b and 53b of the upper plate 50. In the connecting portion 52, a second fitting hole 59 is each formed at the same position in the circumferential direction as the first fitting hole 58.

As illustrated in FIG. 9, the reinforcing plate 56 is a circular plate member having an outer diameter substantially equal to the inner diameter of the connecting portion 52, and has a hole facing the chain fixing hole 53 and the first fitting holes 58 provided in the upper plate 50 in the same shape. As illustrated in FIG. 9, the rib plate 57 further includes a rib body 57a, a first fitting portion 57b provided at an upper end of the rib body 57a and fittable to the first fitting hole 58, and a second fitting portion 57c provided at a lower end of the rib body 57a and fittable to the second fitting hole 59.

In a state where the reinforcing plate 56 is in contact with the lower surface of the upper plate 50, the first fitting portions 57b of the respective rib plates 57 are fitted into the first fitting holes 58, the second fitting portions 57c of the respective rib plates 57 are fitted into the second fitting holes 59, and the first fitting portions 57b of the respective rib plates 57 are welded to the upper plate 50, whereby the reinforcing plate 56 is sandwiched between the upper plate 50 and the rib bodies 57a of the four rib plates 57 and is fixed to the lower surface of the upper plate 50. However, if the strength of the upper plate 50 is sufficient, the reinforcing plate 56 may be omitted.

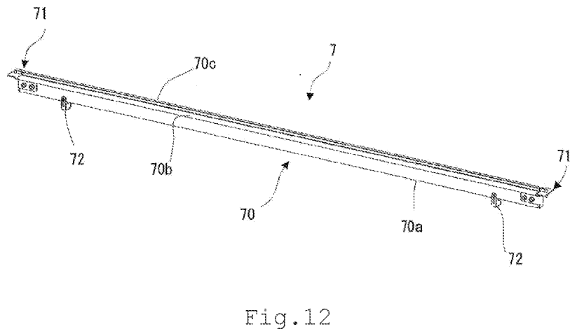

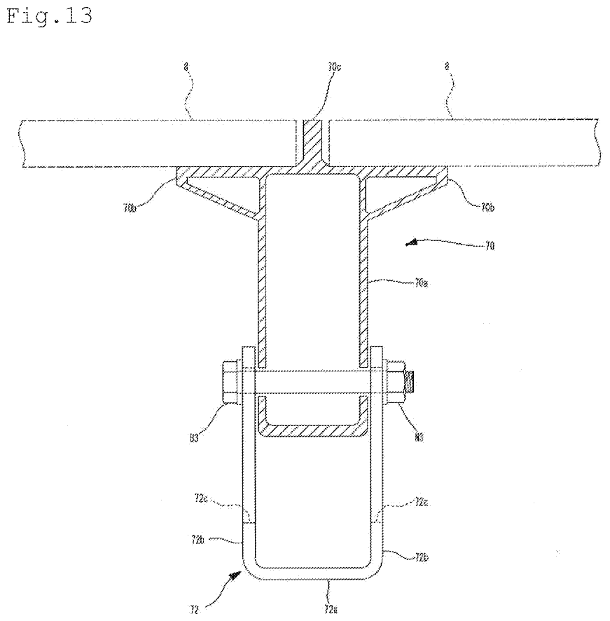

Next, as illustrated in FIG. 1, the structure of the intermediate beam 7 bridged between the adjacent longitudinal beams 2 and 2 will be described in detail. As illustrated in FIG. 12, the intermediate beam 7 of the present embodiment includes an intermediate beam body 70 and hooking portions 71 provided at both end portions of the intermediate beam body 70 in the longitudinal direction. Specifically, as illustrated in FIG. 13, the intermediate beam body 70 includes a body portion 70a having a rectangular tubular cross section, projecting portions 70b and 70b that project laterally from both side ends in the width direction of the upper portion of the body portion 70a and have upper surfaces flush with the upper surface of the body portion 70a, and a protruding portion 70c that rises from the center in the width direction of the upper portion of the body portion 70a and extends along the axial direction of the body portion 70a.

In addition, as illustrated in FIGS. 12 and 13, a grip portion 72 is connected to both sides of the body portion 70a of the intermediate beam body 70 in the axial direction, and the grip portion 72 functions as a handle of the intermediate beam 7.

Specifically, as illustrated in FIG. 13, the grip portion 72 includes a bottom piece 72a having a rectangular plate-shape and a pair of opposing pieces 72b and 72b that stand upright from both ends of the bottom piece 72a and face each other, and each of the opposing pieces 72b is formed with long holes 72c that extend along an extending direction of the grip portion and face each other. Then, in a state where each of the long holes 72c faces a hole (not illustrated) provided in the body portion 70a of the intermediate beam body 70, a bolt B3 is inserted into the hole provided in the body portion 70a, and a nut N3 is screwed and fastened to the bolt B3 from the opposite side, so that the grip portion 72 is movably connected to the intermediate beam body 70 along the extending direction of the long hole 72c. Therefore, when the grip portion 72 is moved so as to bring the bottom piece 72a closer to the body portion 70a, the height of the intermediate beam 7 can be lowered, so that a space required for storing the intermediate beam 7 can be reduced.

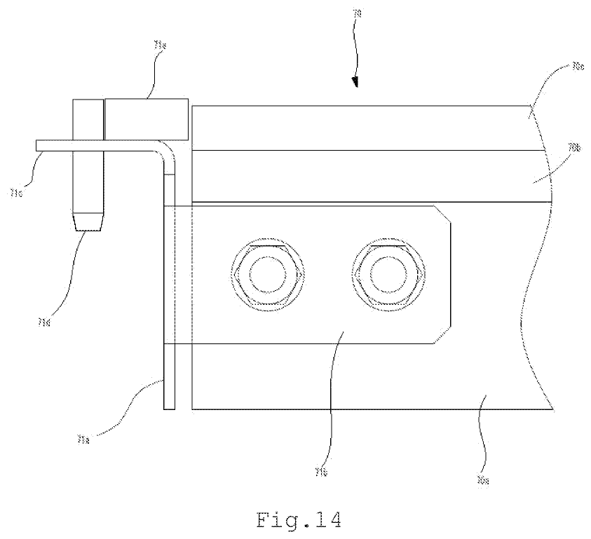

In addition, as illustrated in FIG. 14, the hooking portion 71 of the present embodiment includes: a vertical piece 71a in a flat plate shape extending along the height direction of the body portion 70a of the intermediate beam body 70; a pair of side plates 71b and 71b extending perpendicularly to the vertical piece 71a from both side ends of the vertical piece 71a and fastened to the end portion of the body portion 70a at two places with bolts and nuts not illustrated in a state of sandwiching the end portion of the body portion 70a; a horizontal piece 71c in a flat plate shape extending from the upper end of the vertical piece 71a toward the opposite intermediate beam side; a pin body 71d inserted into a hole (not illustrated) vertically penetrating the horizontal piece 71c and having a distal end protruding downward from the horizontal piece 71c; an upright piece 71e extending from the proximal end of the pin body 71d toward the intermediate beam body 70 and welded to the upper surface of the horizontal piece 71c. As illustrated in FIGS. 12 and 14, the upright piece 71e has a rectangular flat plate shape, and the thickness of the upright piece 71e is the same as the thickness of the protruding portion 70c of the intermediate beam body 70, so that a difference in level is not formed between the upright piece 71e and the protruding portion 70c when the intermediate beam 7 is viewed from the axial direction. In addition, as described above, the intermediate beam 7 of the present embodiment is formed by connecting the intermediate beam body 70 and the hooking portion 71, which are configured as separate members, in a detachable manner using bolts and nuts that do not denote each other.

Therefore, in the present embodiment, the intermediate beam body 70 can be made of aluminum, which is lightweight but time-consuming to weld, and the hooking portion 71 can be made of steel having high rigidity. Thus, when the intermediate beam body 70 is made of aluminum, the intermediate beam 7 is lighter than when the intermediate beam 7 is made of only steel, so that it is easy to carry and to install the intermediate beam 7.

However, the intermediate beam body 70 may be formed of a material other than aluminum. When the intermediate beam body 70 is made of, for example, steel, the intermediate beam body 70 and the hooking portion 71 may be integrated by welding. In addition, the structure of the intermediate beam 7 of the present embodiment is an example, and is not limited to the above-described structure.

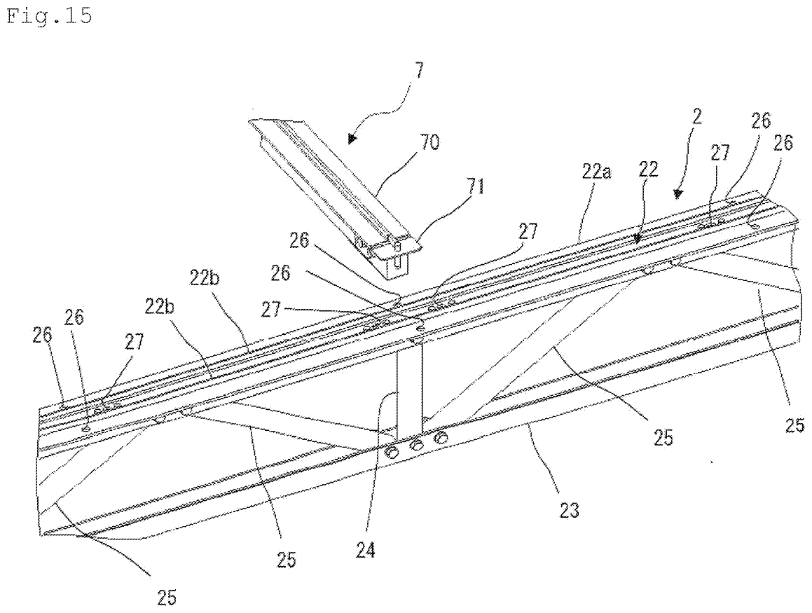

Then, as illustrated in FIG. 15, the intermediate beams 7 configured as described above are bridged between the longitudinal beams 2 and 2 by inserting the pin bodies 71d of the respective hooking portions 71 into the hooking holes 26 provided in the respective scaffolding board support portions 22a of the pair of longitudinal beams 2 and 2 constituting the frame body 6. In addition, in the present embodiment, since three hooking holes 26 are provided on one side of the scaffolding board support portion 22a of one longitudinal beam 2, it is possible to bridge three intermediate beams 7 between the longitudinal beams 2 and 2 of one frame body 6 as illustrated in FIG. 1.

Next, the scaffolding board 8 bridged between the longitudinal beams 2 and 2 will be described in detail. As illustrated in FIG. 1, the scaffolding board 8 of the present embodiment is a wooden rectangular plate member. Note that the material of the scaffolding board 8 is not particularly limited as long as necessary strength is secured, but when the scaffolding board 8 is made of wood, the scaffolding board 8 is lightweight, so that the scaffolding board 8 is easy to carry, and installation work of the scaffolding board 8 is easy. When the scaffolding board 8 is made of metal, the scaffolding board 8 is preferably made of lightweight metal such as aluminum.

In addition, in the scaffolding device 1 of the present embodiment, as illustrated in FIG. 1, the scaffolding boards 8 are installed between the pair of longitudinal beams 2 and 2, at two places on the front-side and the depth-side in the depth direction of the frame body 6 between the lateral beams 3 and the intermediate beams 7 facing each other, and at two places between the intermediate beams 7 and 7 facing each other among the three intermediate beams, respectively. Therefore, in the present embodiment, four scaffolding boards 8 are installed for one frame body 6.

As described above, when the scaffolding of one scaffolding unit A is composed of four scaffolding boards 8, the area per one scaffolding board 8 is small when the area of the frame body 6 of the scaffolding unit A is the same as compared with a case where the scaffolding of one scaffolding unit A is composed of one scaffolding board 8 or a case where the scaffolding of one scaffolding unit is composed of two scaffolding boards as in the scaffolding device of JP 5820848 B. Therefore, since the weight per scaffolding board 8 can also be reduced as compared with the one in the related art, it is easy to carry the scaffolding board 8, and it is also easy to install the scaffolding board 8.

Note that the number of scaffolding boards 8 constituting the scaffolding of one scaffolding unit A is not limited to four, and if the number of scaffolding boards 8 is three or more, the weight per scaffolding board 8 can be reduced as compared with the one in the related art.

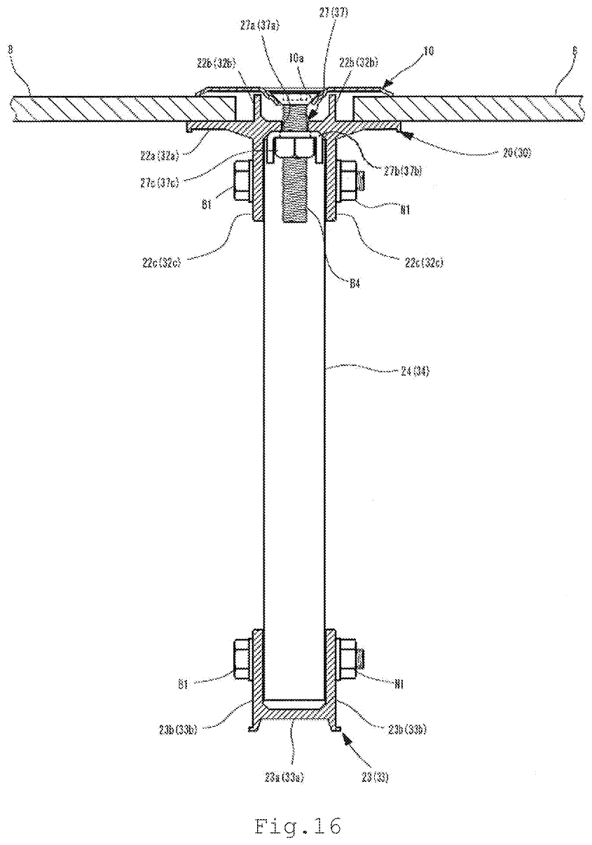

As illustrated in FIGS. 13 and 16, the scaffolding board 8 is placed on the scaffolding board support portions 22a (32a) of each of the longitudinal beams 2 and the lateral beams 3 and the projecting portion 70b of the intermediate beam 7, and bridged between the pair of longitudinal beams 2 and 2.

Further, the scaffolding board 8 installed on the front-side and the depth-side in the depth direction of the frame body 6 is surrounded by the positioning piece 22b of the longitudinal beam 2, the positioning piece 32b of the lateral beam 3, and the protruding portion 70c of the intermediate beam 7, and the scaffolding board 8 installed between the intermediate beams 7 and 7 of three intermediate beams of the frame body 6 is surrounded by the positioning piece 22b of the longitudinal beam 2 and the protruding portion 70c of the intermediate beam 7. Therefore, the scaffolding board 8 bridged between the pair of longitudinal beams 2 and 2 is positioned by being restricted from moving in the horizontal direction.

As illustrated in FIGS. 13 and 16, the thickness of the scaffolding board 8 of the present embodiment is equal to the protrusion height of the positioning pieces 22b and 22b (32b and 32b) and the protruding portion 70c. Therefore, the positioning pieces 22b and 22b (32b and 32b) and the protruding portion 70c do not protrude above the scaffolding board 8 from the gap between the adjacent scaffolding boards 8 and 8. Therefore, it is possible to prevent the worker from stumbling over the positioning pieces 22b and 22b (32b and 32b) and the protruding portion 70c.

Further, in the present embodiment, as illustrated in FIGS. 1 and 16, there is provided a fixing plate 10 respectively fixed to the upper chords 22 (32) of each of the longitudinal beams 2 and the lateral beams 3 so as to sandwich the scaffolding board 8 placed on the scaffolding board support portion 22a (32a), together with the scaffolding board support portions 22a (32a) to prevent the scaffolding board 8 from falling off from the frame body 6.

The fixing plate 10 provided in this manner is provided along the longitudinal direction of the upper chords 22 (32) of each of the longitudinal beams 2 and the lateral beams 3, and fills a gap between the scaffolding boards 8 and 8 adjacent on one longitudinal beam 2 and lateral beam 3 to eliminate a difference in level, and presses the scaffolding board 8 toward the scaffolding board support portion 22a (32a) to prevent lifting of the scaffolding board 8.

Specifically, as illustrated in FIGS. 1 and 16, the fixing plate 10 of the present embodiment is a rectangular plate member having a plurality of bolt insertion holes 10a disposed at the same interval as the plurality of screw holes 27 (37) provided in the scaffolding board support portion 22a (32a).

Here, as illustrated in FIG. 16, the screw hole 27 (37) is formed by a nut 27c (37c) provided on a lower surface between the positioning pieces 22b and 22b (32b and 32b) of the scaffolding board support portion 22a (32a) via a fixture 27b (37b), and a hole 27a (37a) provided at a place where the nut 27c (37c) of the scaffolding board support portions 22a and 22a (32a and 32a) is attached and allowing insertion of a bolt.

Then, as illustrated in FIG. 16, the fixing plate 10 is put on the scaffolding boards 8 placed on the left and right sides in the drawing with the positioning pieces 22b and 22b (32b and 32b) of the scaffolding board support portion 22a (32a) of each of the longitudinal beam 2 and the lateral beam 3 interposed therebetween, a bolt B4 is inserted into the bolt insertion hole 10a of the fixing plate 10 in a state where the bolt insertion hole 10a is allowed to face the screw hole 27 (37) of each of the longitudinal beam 2 and the lateral beam 3, and the bolt B4 is screwed into the nut 27c (37c) of the screw hole 27 (37), so that the fixing plate 10 is pressed against the longitudinal beam 2 and the lateral beam 3 by the head of the bolt B4 and fixed to the longitudinal beam 2 and the lateral beam 3.

In the present embodiment, the two fixing plates 10 are respectively fixed to one longitudinal beam 2 and lateral beam 3, but the installing number of fixing plates 10 and the installation positions thereof may be arbitrarily determined as necessary, and the fixing plates 10 may not be fixed to all screw holes 27 (37) of the longitudinal beam 2 and the lateral beam 3.

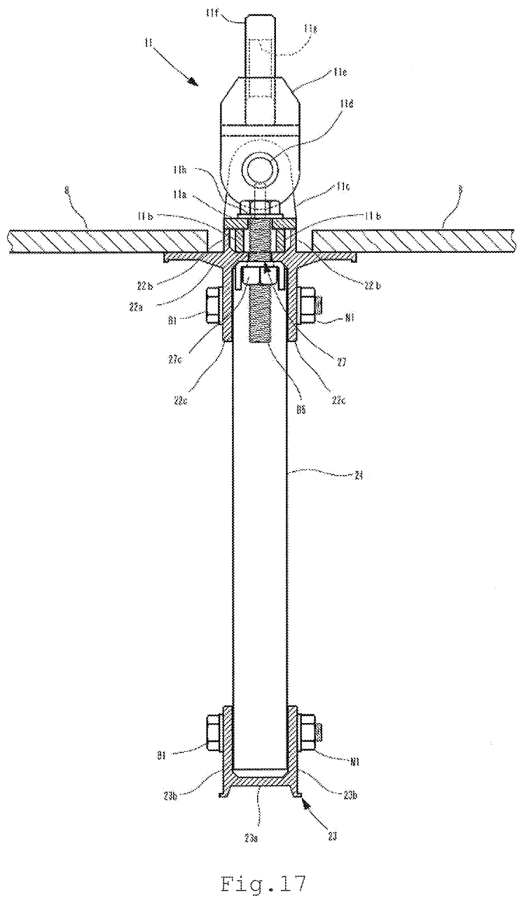

As illustrated in FIGS. 1 and 17, a bracket 11 to which the chain 9 as a hanging member for hanging the frame body 6 can be attached can be connected to the screw hole 27 of the longitudinal beam 2.

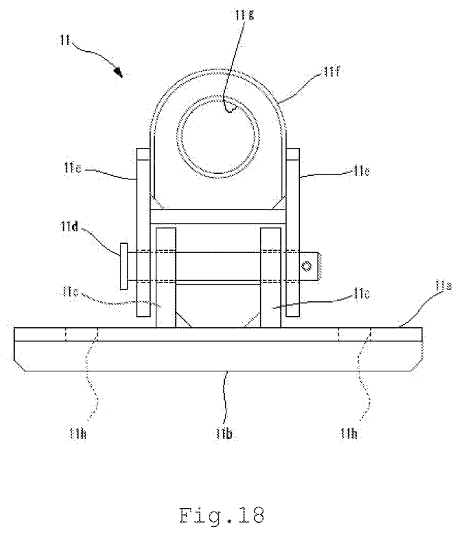

Specifically, as illustrated in FIGS. 17 and 18, the bracket 11 of the present embodiment includes a rectangular bottom plate 11a, a pair of restricting pieces 11b and 11b protruding from a lower portion of the bottom plate 11a and inserted between the positioning pieces 22b and 22b and facing the positioning pieces 22b and 22b, a pair of supporting pieces 11c and 11c protruding from an upper portion of the bottom plate 11a and facing each other, a pair of rotating pieces 11e and 11e rotatably connected to the pair of supporting pieces 11c and 11c via a rotating pin 11d, and a chain holding portion 11f fixed between the rotating pieces 11e and 11e and having a communication hole 11g through which the chain 9 can be inserted.

In addition, the bottom plate 11a is provided with two holes 11h and 11h disposed at the same interval as the two screw holes 27 and 27 disposed at the center in the axial direction of the beam body 20 of the longitudinal beam 2 in FIG. 5.

Then, as illustrated in FIG. 17, in a state where the holes 11h and 11h of the bottom plate 11a are allowed to face the two screw holes 27 and 27 disposed at the center in the axial direction of the beam body 20, the bolt B5 is inserted into each hole 11h of the bottom plate 11a, and the bolt B5 is screwed into the nut 27c of the screw hole 27, whereby the bracket 11 is fixed to the longitudinal beam 2. At this time, since the bolt B5 can be inserted into the hole 11h of the bottom plate 11a in a state where the restricting pieces 11b and 11b are inserted between the positioning pieces 22b and 22b to restrict the movement of the bracket 11 in the width direction with respect to the longitudinal beam 2, the hole 11h of the bottom plate 11a and the screw hole 27 can be easily positioned.

Although not illustrated in detail, the chain 9 can be attached to the frame body 6 via the bracket 11 by inserting the chain 9 into the communication hole 11g of the bracket 11 and hooking the chain 9 on the bracket 11. Therefore, in the scaffolding device 1, the chain 9 suspending the scaffolding device 1 can be attached to a place other than the place where the coupling member 5 is disposed, and the loading capacity of the scaffolding device 1 can be increased.

Furthermore, in the bracket 11 of the present embodiment, since the rotating pieces 11e and 11e to which the chain holding portion 11f is fixed are rotatably connected to the supporting pieces 11c and 11c, even if the position of the chain 9 connected to the building structure or the construction structure is not right above the bracket 11, the rotating pieces 11e and 11e rotate so as not to apply a moment on the bracket 11.

In addition, as illustrated in FIG. 17, the width (left and right width in the drawing) of the bracket 11 of the present embodiment is narrower than the width between the scaffolding boards 8, 8 adjacent in the width direction. Specifically, the length of the bracket 11 protruding from the upward extension line of the outer end surface of each of the positioning pieces 22b and 22b in the bracket 11 is shorter than half of the length obtained by subtracting the length of the scaffolding board 8 from the length between the positioning pieces 22b and 22b in the longitudinal beams 2 and 2 (lateral beams 3 and 3). Therefore, even in a state where the bracket 11 is fixed to the longitudinal beam 2, the scaffolding board 8 can be placed on the scaffolding board support portion 22a of the longitudinal beam 2 without being disturbed by the bracket 11.

In the present embodiment, the bracket 11 is attached only to the longitudinal beam 2, but the bracket 11 may be attached only to the lateral beam 3 or to both the longitudinal beam 2 and the lateral beam 3. In addition, the configuration of the bracket 11 of the present embodiment is an example, and is not limited to the above-described structure as long as the chain 9 as a hanging member can be attached. In addition, the bracket 11 may be omitted if the loading capacity of the scaffolding device 1 is not insufficient.

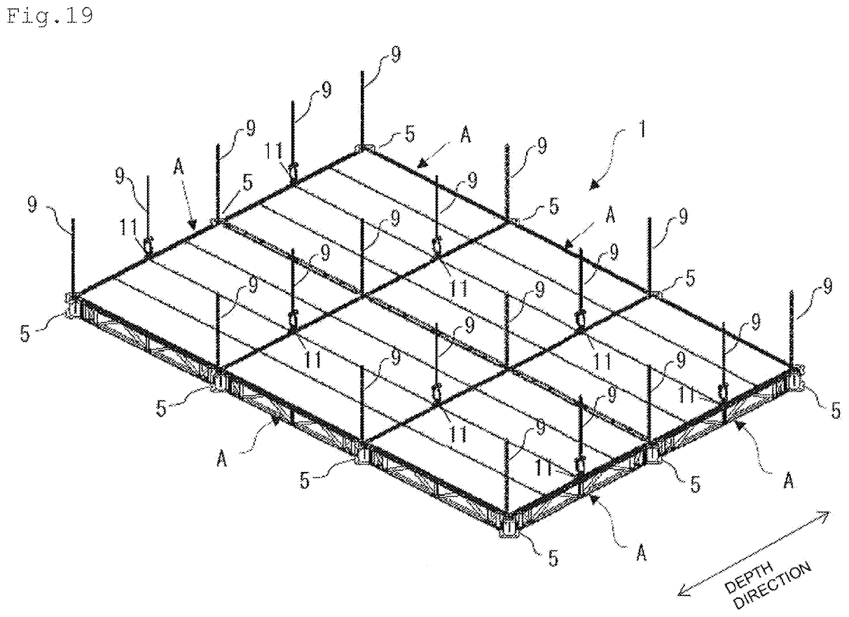

Next, a method of assembling the scaffolding device 1 of the present embodiment will be described in detail. First, the scaffolding device 1 configured by connecting a plurality of scaffolding units A in the depth direction and the width direction is assembled on the ground. Then, the upper end of the chain 9 connected to the coupling member 5 and the bracket 11 provided in each scaffolding unit A (hereinafter, referred to as “existing scaffolding unit A”) of the scaffolding device 1 assembled on the ground is attached to the building structure or the construction structure side, and the chain 9 is wound up by a heavy machine or a chain block, so that the scaffolding device 1 is suspended from the building structure or the construction structure as illustrated in FIG. 19.

In the present embodiment, as illustrated in FIG. 19, the scaffolding device 1 includes six existing scaffolding units A disposed in three rows in the width direction and two rows in the depth direction, and the existing scaffolding units A and A adjacent in the width direction have the longitudinal beam 2 as a shared component, and the existing scaffolding units A and A adjacent in the depth direction have the lateral beam 3 as a shared component. Note that the number of existing scaffolding units A constituting the scaffolding device 1 may be appropriately determined as necessary, and may be at least one.

Next, a step of connecting the scaffolding unit A1 for expansion to the existing scaffolding unit A of the scaffolding device 1 suspended on the building structure or the construction structure to expand the floor board area of the scaffolding device 1 will be described in detail. Here, for convenience of description, the components of the scaffolding unit A1 for expansion will be described with reference signs different from the components of the existing scaffolding unit A. However, the components of the scaffolding unit A1 for expansion and the components of the existing scaffolding unit A are the same components.

First, a coupling member 5A for expansion is connected to one end of a longitudinal beam 2A for expansion in advance, and the bracket 11 is attached to the screw holes 27 and 27 at the center in the axial direction.

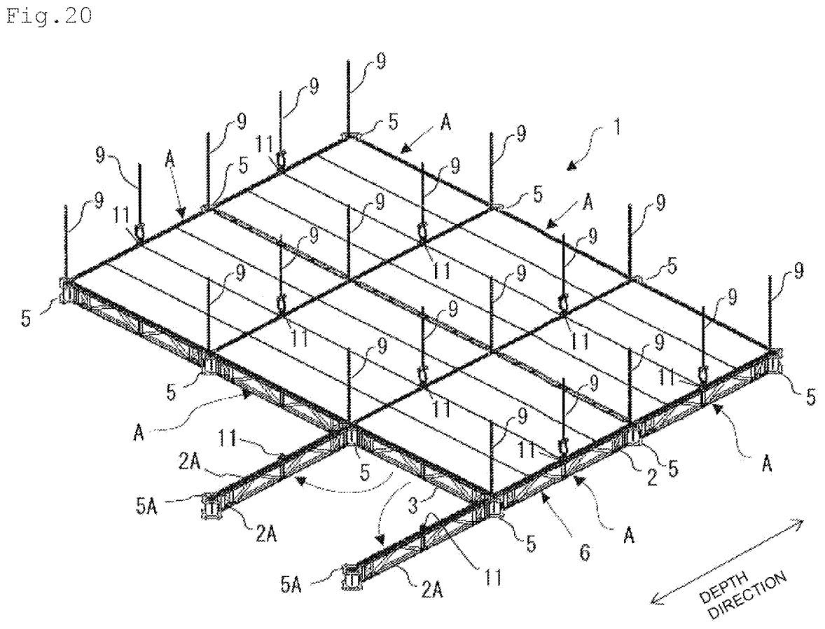

Then, as illustrated in FIG. 20, the other end of the longitudinal beam 2A for expansion to which the coupling member 5A for expansion is attached at the one end is connected rotatably in the horizontal direction only by the fixing pin P1 to each existing coupling member 5 disposed on one side (left side in the drawing), which is the expanding side of the existing frame body 6 of the existing scaffolding unit A. At this time, the worker performs work on one existing scaffolding unit A, and connects one end of the longitudinal beam 2A for expansion to the existing coupling member 5 in a state where the one end of the longitudinal beam 2A is pulled toward the scaffolding unit A where the work is performed. From this state, the worker rotates the one end of each of the longitudinal beams 2A for expansion outward in the horizontal direction so as to be away from the scaffolding unit A with each existing coupling member 5 as a fulcrum, thereby disposing the pair of longitudinal beams 2A for expansion so as to be parallel to each other along the depth direction. Thereafter, the other end of the longitudinal beam 2A for expansion and each existing coupling member 5 are non-rotatably fixed by the anti-rotation pin P2.

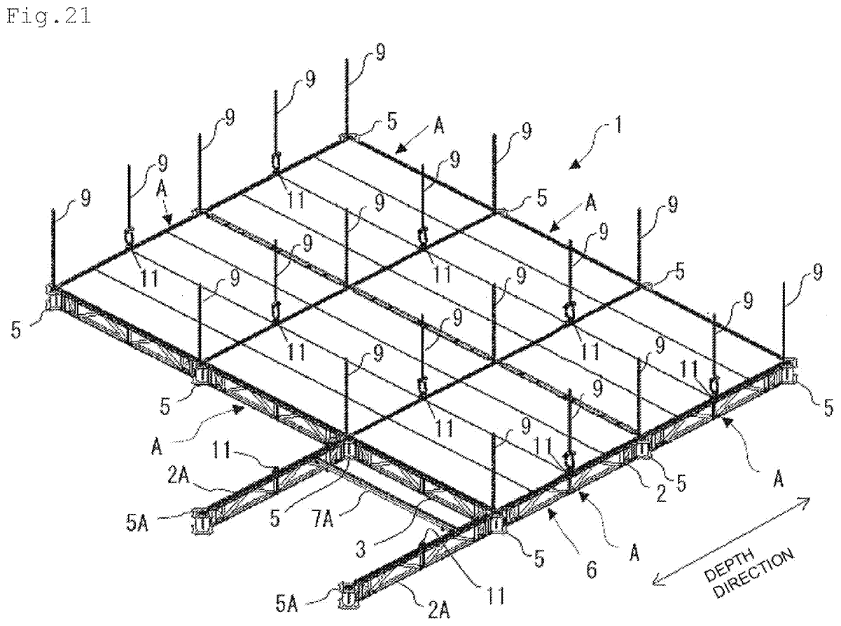

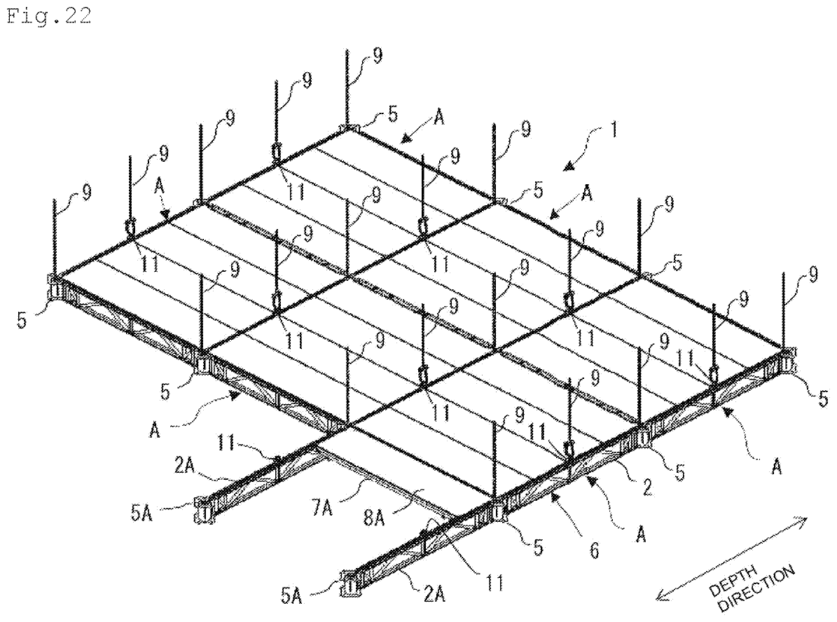

Next, as illustrated in FIG. 21, the hooking portions 71 provided at both ends of the first intermediate beam 7A for expansion are hooked to the hooking holes 26 located on the most front-side of the longitudinal beams 2A for expansion when viewed from the existing scaffolding unit A, and the first intermediate beam 7A for expansion is bridged between the longitudinal beams 2A and 2A for expansion. Thereafter, as illustrated in FIG. 22, the first scaffolding board 8A for expansion is bridged between the longitudinal beams 2A and 2A for expansion while being supported by the existing lateral beam 3 and the first intermediate beam 7A for expansion of the existing scaffolding unit A. The worker performs this work on the existing scaffolding unit A, but in the scaffolding device 1 of the present embodiment, since three intermediate beams 7 are provided for one frame body 6, the distance from the existing scaffolding unit A to the first intermediate beam 7A for expansion is short, and the worker can safely perform the above work.

Although not illustrated, also for the second and third intermediate beams 7A for expansion and scaffolding board 8A, the intermediate beam 7A for expansion and the scaffolding board 8A for expansion are bridged between the longitudinal beams 2A and 2A for expansion in order from the front-side in the same procedure as that of the first intermediate beam 7A for expansion and the first scaffolding board 8A for expansion. Even in performing this work, since the width between the intermediate beams 7A and 7A for expansion is narrow, the worker can safely perform the work without largely leaning out of the scaffolding board 8A for expansion installed between the longitudinal beams 2A and 2A for expansion. The second and third scaffolding boards 8A for expansion are supported by two intermediate beams 7A and 7A for expansion adjacent to each other in the depth direction.

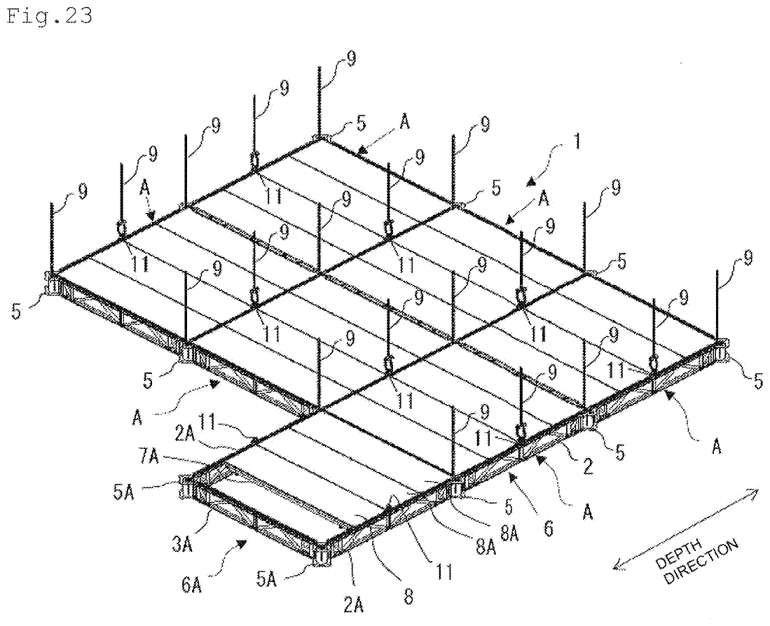

Next, as illustrated in FIG. 23, a lateral beam 3A for expansion is bridged between the coupling members 5A and 5A for expansion connected to one ends of the respective longitudinal beams 2A for expansion. Hereinafter, a procedure for bridging the lateral beam 3A for expansion between the coupling members 5A and 5A for expansion will be described in detail.

First, when the coupling member 5A for expansion is connected to one end of the longitudinal beam 2A for expansion, the coupling member 5A for expansion is connected to the one end of the longitudinal beam 2A for expansion only by the fixing pin P1, and is made rotatable in the horizontal direction with respect to the one end of the longitudinal beam 2A for expansion.

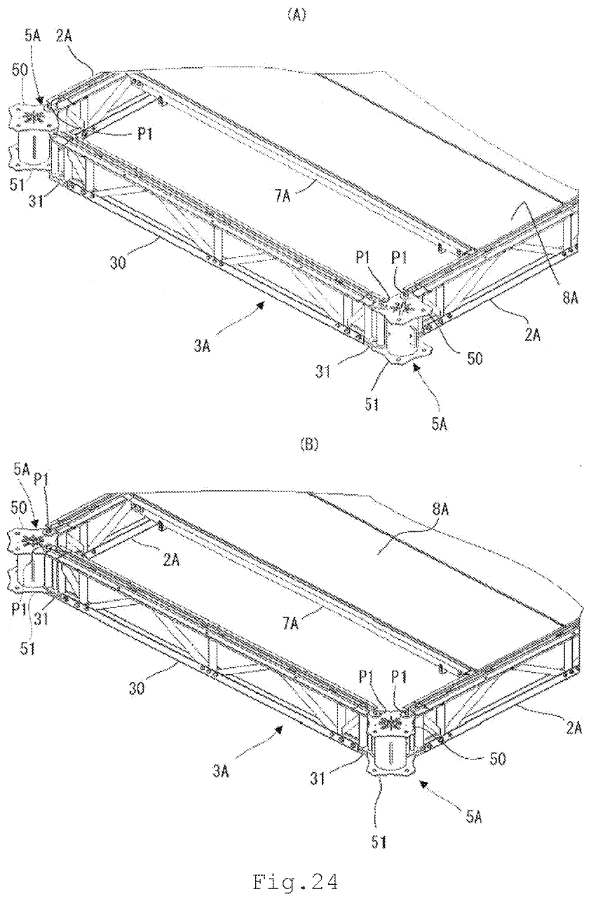

In this state, as illustrated in FIG. 24(A), in a state where the coupling member 5A for expansion on the right side in the drawing is rotated toward the side (inward) of the longitudinal beam 2A for expansion on the left side in the drawing and the coupling member 5A for expansion on the right side in the drawing is brought close to the scaffolding board 8A for expansion, the fixing pin P1 is inserted in a state where the connecting portion 31 at the right end in the drawing, which is one end of the lateral beam 3A for expansion, is moved from the front-side to the depth-side in the depth direction to overlap above and below the pair of plates 50 and 51 of the coupling member 5A for expansion on the right side in the drawing, and the holes (the first attachment hole 31d and the first counter hole 31g) of the connecting portion 31 on the right side in the drawing and the insertion holes 50a and 51a of the coupling member 5A for expansion on the right side in the drawing are allowed to face each other, so that the right end of the lateral beam 3A for expansion in the drawing is connected to the coupling member 5A for expansion on the right side in the drawing so as to be rotatable in the horizontal direction.

Thereafter, as illustrated in FIG. 24(B), the coupling member 5A for expansion on the right side in the drawing is rotated toward the opposite side (outer side) of the longitudinal beam 2A for expansion on the left side in the drawing and the fixing pin P1 is inserted in a state where the connecting portion 31 at the left end in the drawing, which is the other end of the lateral beam 3A for expansion, is overlapped above and below the plates 50 and 51 of the coupling member 5A for expansion on the left side in the drawing, and the holes (the first attachment hole 31d and the first counter hole 31g) of the connecting portion 31 at the left end in the drawing of the lateral beam 3A for expansion and the insertion holes 50a and 51a of the plates 50 and 51 of the coupling member 5A for expansion on the left side in the drawing are allowed to face each other, so that the left end of the lateral beam 3A for expansion in the drawing is connected to the coupling member 5A for expansion on the left side in the drawing so as to be rotatable in the horizontal direction.

When the coupling member 5A for expansion is not fixed to one end of the longitudinal beam 2A for expansion but is rotatably connected in the horizontal direction in this manner, the one coupling member 5A for expansion can be brought close to the scaffolding board 8A for expansion by rotating the one coupling member 5A for expansion inward, so that the extent of the worker leaning out of the scaffolding board 8A for expansion is reduced, and the scaffolding device 1 can be assembled more safely.

Further, when the scaffolding device 1 is assembled, there is a case where it is difficult to bridge the lateral beam 3A for expansion between the coupling members 5A and 5A for expansion due to a dimensional error of each component constituting the scaffolding device 1, a positional deviation at the time of assembling each component, and the like. In contrast, in the present embodiment, the holes (first attachment hole 31d, first counter hole 31g) of the connecting portion 31 at the other end of the lateral beam 3A for expansion and the insertion holes 50a and 51a of the plates 50 and 51 of the other coupling member 5A for expansion can be brought to face each other simply by rotating outward one of the coupling members 5A for expansion to which one end of the lateral beam 3A for expansion is connected in a state of being rotated inward, so that it is possible to easily align the hole of the connecting portion 31 and the holes of the plates 50 and 51 of the coupling member 5A for expansion even if there is a dimensional error in each component constituting the scaffolding device 1, misalignment during assembly of each component, or the like.

Therefore, when the lateral beam 3A for expansion is bridged between the coupling members 5A and 5A for expansion by the method described above, the assembly work of the scaffolding device 1 can be performed more safely and easily.

In the present embodiment, both the right and left coupling members 5A for expansion are connected to one ends of the right and left longitudinal beams 2A for expansion so as to be rotatable in the horizontal direction. However, if at least one of the coupling members 5A for expansion is connected to one end of the longitudinal beam 2A for expansion so as to be rotatable in the horizontal direction, the lateral beam 3A for expansion can be bridged between the coupling members 5A and 5A for expansion in the same procedure as described above.

However, both the right and left coupling members 5A for expansion may be non-rotatably fixed to the longitudinal beams 2A for expansion by the anti-rotation pins P2 in advance. Even in this case, the lateral beam 3A for expansion can be bridged between the coupling members 5A and 5A for expansion.

Referring back to the previous drawings, although not illustrated, the end portion of each of the longitudinal beams 2A for expansion and the end portion of each of the lateral beams 3A for expansion are non-rotatably fixed to each of the coupling members 5A for expansion via the anti-rotation pin P2.

Then, the fourth scaffolding board 8A for expansion is bridged between the longitudinal beams 2A and 2A for expansion while being supported by the third intermediate beam 7A for expansion and the lateral beam 3A for expansion.

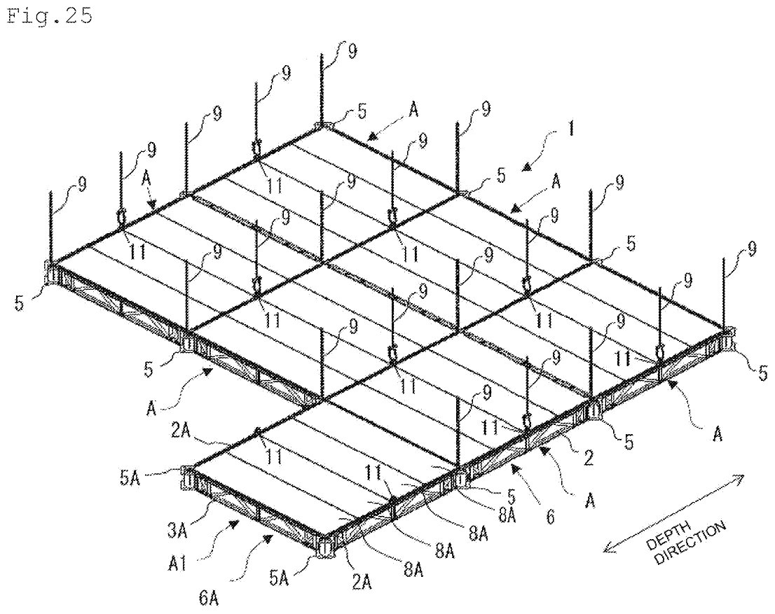

Finally, by attaching the lower end of the chain 9 whose upper end is connected to the building structure or the construction structure side to the coupling member 5A for expansion and the bracket 11 previously attached to the longitudinal beam 2A for expansion, the scaffolding unit A1 for expansion is suspended from the building structure or the construction structure as illustrated in FIG. 25.

At this time, since the bracket 11 is attached to the longitudinal beam 2A for expansion in advance, the lower end of the chain 9 can be attached to the bracket 11 immediately after all the scaffolding boards 8A for expansion are installed in one frame body 6A for expansion, and the time during which the scaffolding unit A1 for expansion is not suspended via the chain 9 to be attached to the bracket 11 can be shortened, so that safety is improved.

By repeating the above procedure in the width direction or the depth direction, the scaffolding device 1 of the present embodiment can expand the floor board area to a freely-selected position in a state of being suspended from a building structure or a construction structure. Then, after expanding the floor board area of the scaffolding device 1 by assembling the plurality of scaffolding units A1 for expansion, by fixing the fixing panel 10 to each of the longitudinal beams 2 and each of the lateral beams 3, it is possible to prevent the scaffolding board 8 from falling off.

Since the worker can perform, on one scaffolding unit A, the work of connecting and unfolding the longitudinal beams 2 and 2 to the existing scaffolding units A, in a case where the plurality of existing scaffolding units A are connected in the width direction and the scaffolding units A1 for expansion forming one row in the width direction are installed in the depth direction with respect to the plurality of existing scaffolding units A, the worker only needs to prepare every other one of the existing scaffolding units A arranged in the width direction with respect to the longitudinal beams 2 and 2 to perform the work, so that the work efficiency is improved.

With the method of assembling the scaffolding device 1 described above, it is possible to omit a step of connecting the end portions of the plurality of longitudinal beams 2 and the lateral beams 3 respectively to each one of the coupling members 5 at once. Therefore, it becomes less likely to make a mistake in determining as to which of the four insertion holes 50a and 51a provided in the coupling member 5 the longitudinal beam 2 and the lateral beam 3 are to be connected. Therefore, with the above-described method of assembly, a mistake in assembly is less likely to occur, and assembly workability is improved.

In addition, in the scaffolding device 1 of the present embodiment, as described above, since the scaffolding of the scaffolding unit A is composed of three or more scaffolding boards 8, the width of the scaffolding board 8 is narrowed and the weight per scaffolding board 8 can be reduced as compared with the case where the scaffolding of the conventional scaffolding unit is composed of two or less scaffolding boards. Furthermore, the beam body 20 (30) of each of the longitudinal beam 2 and the lateral beam 3 and the intermediate beam body 70 of the intermediate beam 7 are made of lightweight aluminum, so that weight reduction is achieved. Therefore, in the present embodiment, since it is easy to carry each component constituting the scaffolding device 1, the assembly work of the scaffolding device 1 is facilitated, and the time required for assembling the scaffolding device 1 can be shortened.

In addition, since the width of the scaffolding board 8 is narrowed, the width between the intermediate beams 7 and 7 supporting the scaffolding board 8 is also narrowed, and the worker can assemble the scaffolding device 1 without greatly leaning out of the existing scaffolding unit A or the installed scaffolding board 8 for expansion. Therefore, the scaffolding device 1 can be assembled more safely.

Note that the method of assembling the scaffolding device 1 described above is an example, and the method is not limited to the above method as long as the scaffolding device 1 can be assembled.

As described above, the scaffolding device 1 according to the present embodiment includes a frame body 6 including a pair of longitudinal beams 2 and 2, a pair of lateral beams 3 and 3, and four coupling members 5 disposed between respective end portions of the longitudinal beams 2 and respective end portions of the lateral beams 3 to rotatably connect the longitudinal beams 2 and the lateral beams 3 on the same plane, two or more intermediate beams 7 bridged between the longitudinal beams 2 and 2 at a predetermined interval; and scaffolding boards 8 bridged between the longitudinal beams 2 and 2 and supported by at least one of the intermediate beams 7, the number of the scaffolding boards being larger than the installing number of the intermediate beams 7 by one.

With this configuration, since the number of the scaffolding boards 8 to be installed in the frame body 6 is at least three or more, the width of the scaffolding board 8 is narrowed and the weight per scaffolding board 8 can be reduced as compared with the case where the number of the scaffolding boards 8 to be installed in the frame body 6 is two or less as in the conventional manner. Therefore, the assembly work of the scaffolding device 1 is facilitated, and the time required for assembling the scaffolding device 1 can be shortened.

Furthermore, since the width of the scaffolding board 8 is narrowed, the width between the intermediate beams 7 and 7 supporting the scaffolding board 8 is also narrowed. Therefore, at the time of assembling the scaffolding device 1, the worker can perform the work of bridging the next intermediate beam 7 and the scaffolding board 8 between the longitudinal beams 2 and 2 from the scaffolding board 8 bridged between the longitudinal beams 2 and 2 without largely leaning out of the scaffolding board 8. Therefore, the assembly work of the scaffolding device 1 can be performed more safely.

In the present embodiment, the number of the intermediate beams 7 bridged between the longitudinal beams 2 and 2 is three, and the number of the scaffolding boards 8 to be supported by at least one intermediate beam 7 is four. However, if the installing number of the intermediate beams 7 is two or more, and the number of the scaffolding boards 8 to be supported by at least one intermediate beam 7 is three or more, which is one more than the installing number of the intermediate beams 7, the weight per scaffolding board 8 can be made lighter as compared with the one in the related art. In addition, when the installing number of the intermediate beams 7 is two or more and the number of scaffolding boards 8 supported by at least one intermediate beam 7 is three or more, which is one more than the installing number of intermediate beams 7, the width between the intermediate beams 7 and 7 supporting the scaffolding boards 8 is also narrowed, so that the assembly work of the scaffolding device 1 can be more safely performed as described above.

Further, in the present embodiment, the coupling member 5 connects each end portion of the longitudinal beam 2 and each end portion of the lateral beam 3 so as to be rotatable in the horizontal direction, but each end portion of the longitudinal beam 2 and each end portion of the lateral beam 3 may be connected so as to be rotatable in the vertical direction. However, when the coupling member 5 connects each end portion of the longitudinal beam 2 and each end portion of the lateral beam 3 so as to be rotatable in the vertical direction, it is necessary to secure a distance from the scaffolding device 1 to a building structure, a construction structure, or the ground that allows the rotation of the longitudinal beam 2 and the lateral beam 3 in the vertical direction. Therefore, it is preferable that the coupling member 5 connects each end portion of the longitudinal beam 2 and each end portion of the lateral beam 3 so as to be rotatable in the horizontal direction.

In addition, in the scaffolding device 1 of the present embodiment, the longitudinal beam 2 and the lateral beam 3 each include a beam body 20 (30), and connecting portions 21 (31) that are detachably connected to both ends in the longitudinal direction of the beam body 20 (30) and can connect the beam body 20 (30) to the coupling members 5, respectively.

With this configuration, when the beam body 20 (30) or the connecting portion 21 (31) of each of the longitudinal beam 2 and the lateral beam 3 is damaged, it is only necessary to dissemble so as to replace the damaged component, so that maintenance of the scaffolding device 1 becomes easy. It is sufficient that the beam body 20 (30) of at least one of the longitudinal beam 2 and the lateral beam 3 and the connecting portion 21 (31) are detachably connected.

In the scaffolding device 1 of the present embodiment, the beam body 20 (30) is formed of a material having a mass per unit volume smaller than that of the connecting portion 21 (31), and the connecting portion 21 (31) is formed of a material having rigidity higher than that of the beam body 20 (30).

With this configuration, only the connecting portion 21 (31) on which a large shear load acts when the scaffolding device 1 is used is formed of a material having high rigidity, and the beam body 20 (30) having a smaller load acting thereon than that of the connecting portion 21 (31) is formed of a material having a mass per unit volume smaller than that of the connecting portion 21 (31). Therefore, rigidity of the scaffolding device 1 is secured, and the weight of the longitudinal beams 2 or the lateral beams 3 can be reduced without causing a decrease in loading capacity. Therefore, with the above configuration, assembly workability of the scaffolding device 1 is improved.

In the scaffolding device 1 of the present embodiment, the beam body 20 (30) is made of steel and the connecting portion 21 (31) is made of aluminum, but the materials of the beam body 20 (30) and the connecting portion 21 (31) are not particularly limited as long as the beam body 20 (30) is formed of a material having a mass per unit volume smaller than that of the connecting portion 21 (31) and the connecting portion 21 (31) is formed of a material having rigidity higher than that of the beam body 20 (30). However, the beam body 20 (30) and the connecting portion 21 (31) may be integrally formed with the same material.

In addition, in the scaffolding device 1 of the present embodiment, the beam body 20 (30) includes the upper chord 22 (32) and the lower chord 23 (33) disposed in parallel to vertically face each other, at least one strut 24 (34) and a plurality of diagonal bracings 25 (35) that are bridged between the upper chord 22 (32) and the lower chord 23 (33) to connect the upper chord 22 (32) and the lower chord 23 (33), and the upper chord 22 (32), the lower chord 23 (33), the strut 24 (34), and the diagonal bracings 25 (35) are connected to each other in a detachable manner.

With this configuration, even if the components constituting the beam body 20 (30) is damaged or deformed due to aging deterioration or a load, it is only necessary to disassemble so as to replace the damaged or deformed component, which facilitates maintenance of the scaffolding device 1.

In addition, since the components constituting the beam body 20 (30) are connected in a detachable manner, that is, by a method other than welding, in a case where the beam body 20 (30) is made of aluminum, which is a metal requiring time and effort for welding, the beam body 20 (30) can be made into a truss structure while avoiding welding.

In addition, in the scaffolding device 1 of the present embodiment, the upper chord 22 (32) has a scaffolding board support portion 22a (32a) in a flat plate shape that extends along the axial direction of the beam body 20 (30) and supports the scaffolding board 8, and a pair of positioning pieces 22b and 22b (32b and 32b) that stand upright from the upper surface side of the scaffolding board support portion 22a (32a) to face each other and regulate the horizontal movement of the scaffolding board 8 supported by the scaffolding board support portion 22a (32a), a bracket 11 to which the chain 9 as a hanging member for hanging the longitudinal beam 2 or the lateral beam 3 can be attached is connected between the positioning pieces 22b and 22b (32b and 32b) on the scaffolding board support portion 22a, two scaffolding boards 8 are installed with the positioning pieces 22b and 22b interposed therebetween on the scaffolding board support portion 22a, and the width of the bracket 11 is narrower than the width between the two scaffolding boards 8 and 8.

With this configuration, at the time of assembling the scaffolding device 1, even if the bracket 11 is attached in advance to the longitudinal beam 2A for expansion or the lateral beam 3A for expansion, the bracket 11 does not become an obstacle when the scaffolding board 8A for expansion is bridged between the longitudinal beams 2 and 2 for expansion. Therefore, the lower end of the chain 9 can be attached to the bracket 11 immediately after all the scaffolding boards 8A for expansion are installed in the frame body 6A for expansion, and the time during which the scaffolding unit A1 for expansion is not suspended via the chain 9 to be attached to the bracket 11 can be shortened, so that safety is improved.

Further, in the scaffolding device 1 of the present embodiment, in a state where the first attachment holes 21d and 21d (31d and 31d) provided in the connecting portion 21 (31) and the insertion holes 50a and 51a provided in the coupling member 5 face each other, the coupling member 5 is rotatably connected to the longitudinal beam 2 or the lateral beam 3 by the fixing pin P1 inserted into the first attachment holes 21d and 21d (31d and 31d) and the insertion holes 50a and 51a, and in a state where the second attachment holes 21e and 21e (31e and 31e) provided in the connecting portion 21 (31) and the anti-rotation grooves 50b and 51b provided on the outer periphery of the coupling member 5 face each other, by the anti-rotation pin P2 inserted into the second attachment holes 21e and 21e (31e and 31e) and the anti-rotation grooves 50b and 51b, the coupling member 5 is fixed to the longitudinal beam 2 or the lateral beam 3 in a non-rotatable manner.

With this configuration, when the lateral beam 3 is bridged between the coupling members 5 and 5 adjacent to each other in the width direction, if at least one coupling member 5 is rotatably connected to the longitudinal beam 2 only by the fixing pin P1, the one coupling member 5 can be brought close to the scaffolding board 8 side by rotating the one coupling member 5 inward. Therefore, when the worker bridges the lateral beam 3 between the coupling members 5 and 5 from the scaffolding board 8, it is possible to reduce the extent of the worker leaning out of the scaffolding board 8, so that the lateral beam 3 can be bridged between the coupling members 5 and 5 more safely.

Further, when the scaffolding device 1 is assembled, there is a case where it is difficult to bridge the lateral beam 3 between the coupling members 5 and 5 due to a dimensional error of each component constituting the scaffolding device 1, a positional deviation at the time of assembling each component, or the like. However, in the present embodiment, simply by rotating outward one coupling member 5 that is in a state being connected to one end of the lateral beam 3 and being rotated inward, it is possible to easily align the holes (the first attachment hole 31d, the first counter hole 31g) of the connecting portion 31 at the other end of the lateral beam 3 and the insertion holes 50a and 51a of the plates 50 and 51 of the other coupling member 5.

In the scaffolding device 1 according to the present embodiment, at the upper ends of the fixing pin P1 and the anti-rotation pin P2, two protrusions Pa and Pb that protrude from the fixing pin P1 and the anti-rotation pin P2 in the radial direction are provided vertically in line, and the two protrusions Pa and Pb are disposed so as to face the directions intersecting each other when viewed from the axial direction of the fixing pin P1 and the anti-rotation pin P2.

With this configuration, the upper protrusions Pa function as a handle of the fixing pin P1 and the anti-rotation pin P2, and the lower protrusions Pb functions as a stopper of the fixing pin P1 and the anti-rotation pin P2.

In addition, if the upper protrusion Pa and the lower protrusion Pb are disposed in parallel in the vertical direction, it is necessary to provide a certain distance between the holes in order to connect the upper protrusion Pa and the lower protrusion Pb to the fixing pin P1 and the anti-rotation pin P2, because drilling cannot be performed unless the thickness in the vertical direction of the two holes on the upper end side of the fixing pin P1 and the anti-rotation pin P2 is secured. In contrast, as in the present embodiment, when the upper protrusion Pa and the lower protrusion Pb are disposed in the directions intersecting with each other when viewed from the axial direction of the fixing pin P1 and the anti-rotation pin P2, the two holes into which the upper protrusion Pa and the lower protrusion Pb are inserted are disposed at the twisted positions, so that drilling can be performed without difficulty even if the distance between the two holes in the vertical direction is shortened.

Therefore, when the upper protrusion Pa and the lower protrusion Pb are disposed in the directions intersecting with each other when viewed from the axial direction of the fixing pin P1 and the anti-rotation pin P2, the interval between the upper protrusion Pa and the lower protrusion Pb in the vertical direction can be shortened as compared with the case where the upper protrusion Pa and the lower protrusion Pb are disposed in parallel in the vertical direction. Therefore, the fixing pin P1 and the anti-rotation pin P2 are respectively inserted into the first attachment hole 21d (31d) and the second attachment hole 21e (31e), and the protrusion height of the upper ends of the fixing pin P1 and the anti-rotation pin P2 can be lowered in a state where the lower protrusion Pb is caught on the edges of the first attachment hole 21d (31d) or the second attachment hole 21e (31).

Therefore, when the upper protrusion Pa and the lower protrusion Pb are disposed in the directions intersecting with each other as viewed from the axial direction of the fixing pin P1 and the anti-rotation pin P2, even if the plate thickness of the scaffolding board 8 bridged between the longitudinal beams 2 and 2 is reduced in order to reduce the weight of the scaffolding board 8, the upper ends of the fixing pin P1 and the anti-rotation pin P2 do not protrude from the scaffolding board 8, and it is possible to prevent the worker from stumbling over the fixing pin P1 and the anti-rotation pin P2. However, the upper protrusion Pa and the lower protrusion Pb may be disposed in parallel in the vertical direction.

In addition, in the scaffolding device 1 of the present embodiment, the coupling member 5 has a pair of upper and lower plates 50 and 51 disposed in parallel, and a connecting portion 52 connecting the plates 50 and 51 to each other, the plates 50 and 51 respectively have four insertion hole 50a and 51a disposed at equal intervals on the same circumference and facing each other, and four anti-rotation grooves 50b and 51b respectively provided on the outer peripheries of the plates 50 and 51 and at positions respectively facing the insertion holes 50a and 51a when viewed from the center of the plates 50 and 51, the connecting portion 21 (31) has a pair of upper and lower connecting pieces 21c and 21c (31c and 31c) protruding from respective end portions of the beam body 20 (30) along the axial direction, and connecting pieces 21c (31c) respectively have first attachment holes 21d (31d) facing each other, and second attachment holes 21e and 21e disposed at positions facing the anti-rotation grooves 51b and 50b in a state where the first attachment hole 21d (31d) faces any one of the insertion holes 50a and 51a, and the anti-rotation groove 51b provided in the lower plate 51 is formed shallower than the anti-rotation groove 50b provided in the upper plate 50.

Here, since there is a slight gap between the fixing pin P1 to be inserted into the first attachment hole 21d (31d) and the insertion holes 50a and 51a, and the first attachment holes 21d and 21d (31d and 31 d) and the insertion holes 50a and 51a, when the longitudinal beam 2 or the lateral beam 3 is connected to the coupling member 5, the fixing pin P1 is slightly inclined in the first attachment holes 21d and 21d (31d and 31d) and the insertion holes 50a and 51a by the gap due to the moment received from the longitudinal beam 2 or the lateral beam 3. Therefore, in a state where the coupling member 5 is connected to the longitudinal beam 2 or the lateral beam 3 only by the fixing pin P1, the longitudinal beam 2 or the lateral beam 3 is inclined downward according to the inclination angle of the fixing pin P1.

On the other hand, there is also a slight gap between the anti-rotation pin P2 inserted into the second attachment hole 21e (31e) and the second attachment holes 21e and 21e (31e and 31e), and the lower anti-rotation groove 51b provided in the lower plate 51 is formed shallower than the upper anti-rotation groove 50b provided in the upper plate 50. Therefore, anti-rotation pin P2 inserted into the second attachment holes 21e and 21e (31e and 31e) tends to incline in the second attachment holes 21e and 21e (31e and 31e) due to the moment received from the longitudinal beam 2 or the lateral beam 3, but the lower end of the anti-rotation pin P2 is laterally supported by the lower plate 51 to suppress the inclination.

That is, in the present embodiment, since the lower end of the anti-rotation pin P2 is laterally supported by the lower plate 51 even when moment is received from the longitudinal beam 2 or the lateral beam 3, the longitudinal beam 2 or the lateral beam 3 can be horizontally disposed.

In addition, when the height of the coupling member 5 is reduced, the distance between the inner peripheries of the first attachment holes 21d and 21d serving as fulcrums for supporting the inclined fixing pin P1 on the upper side and the lower side is also reduced. Therefore, if the gap between the fixing pin P1 and the first attachment holes 21d and 21d (31d and 31d) and the insertion holes 50a and 51a is the same, the inclination angle of the fixing pin P1 is increased. Therefore, when the height of the coupling member 5 is lowered, the downward inclination of the longitudinal beam 2 and the lateral beam 3 in a state where the coupling member 5 is connected to the longitudinal beam 2 and the lateral beam 3 only by the fixing pin P1 also increases. However, in the present embodiment, as described above, even when moment is received from the longitudinal beam 2 and the lateral beam 3, the lower end of the anti-rotation pin P2 is laterally supported by the lower plate 51, so that the longitudinal beam 2 and the lateral beam 3 are disposed horizontally. Therefore, even if the height of the coupling member 5 is lowered, the above problem does not occur.

Therefore, according to the present embodiment, since the height of the coupling member 5 can be lowered to reduce the weight of the coupling member 5, the assembly workability of the scaffolding device 1 is further improved, and the time required for assembling the scaffolding device 1 can be further shortened.

However, when the downward inclination of the longitudinal beam 2 and the lateral beam 3 due to the inclination of the fixing pin P1 and the anti-rotation pin P2 is within the allowable range, the depths of the anti-rotation groove 50b of the upper plate 50 and the anti-rotation groove 51b provided in the lower plate 51 may be set to be the same.

Although not illustrated, an auxiliary beam each supporting the scaffolding boards 8 may be bridged so as to be in parallel with the longitudinal beams 2, between the lateral beam 3 and the intermediate beam 7 facing each other and between the intermediate beams 7 and 7 facing each other. With this configuration, deflection of the scaffolding board 8 can be prevented, and when the scaffolding board 8 is installed, the scaffolding board 8 can be prevented from falling from the frame surrounded by the pair of longitudinal beams 2 and 2, the pair of lateral beams 3 and 3, and the respective intermediate beams 7.

Further, in the method of assembling the scaffolding device 1 according to the present embodiment including a frame body 6 including a pair of longitudinal beams 2 and 2, a pair of lateral beams 3 and 3, and four coupling members 5 disposed between respective end portions of the longitudinal beams 2 and respective end portions of the lateral beams 3 and rotatably connecting the longitudinal beams 2 and the lateral beams 3 on the same plane, two or more intermediate beams 7 bridged between the longitudinal beams 2 and 2 at a predetermined interval, and scaffolding boards 8 bridged between the longitudinal beams 2 and 2 and supported by at least one intermediate beam 7, the number of the scaffolding boards 8 being one larger than the installing number of the intermediate beams 7, the method includes the steps of: connecting the other ends of the pair of longitudinal beams 2A and 2A for expansion, the longitudinal beams 2A each being attached with a coupling member 5A for expansion at one end, to each of the coupling members 5 disposed on one side of the frame body 6; repeatedly performing, by the same number as the number of intermediate beams 7A to be installed in one frame body 6A, a step of bridging an intermediate beam 7A for expansion between the pair of longitudinal beams 2A and 2A for expansion, and bridging a scaffolding board 8A for expansion between the pair of longitudinal beams 2A for expansion while allowing the scaffolding board 8A to be supported by at least the bridged intermediate beam 7A for expansion, so as to bridge a lateral beam 3A for expansion between the coupling members 5A and 5A for expansion, and a step of bridging another scaffolding board 8A for expansion between the pair of the longitudinal beams 2A and 2A for expansion while allowing the scaffolding board 8A for expansion to be supported by at least the lateral beam 3A for expansion.

With this configuration, since the number of scaffolding boards 8 installed in the frame body 6 is at least three or more, the width of the scaffolding board 8 is narrowed and the weight per scaffolding board 8 can be reduced as compared with the case where the number of scaffolding boards 8 installed in the frame body 6 is two or less as in the conventional manner. Therefore, the assembly work of the scaffolding device 1 is facilitated, and the time required for assembling the scaffolding device can be shortened.

In addition, since the width of the scaffolding board 8 is narrowed, the width between the intermediate beams 7 and 7 supporting the scaffolding board 8 is also narrowed. Therefore, the worker can bridge the next intermediate beam 7A for expansion and the scaffolding board 8A for expansion between the longitudinal beams 2A and 2A for expansion without largely leaning out of the existing scaffolding board 8 or the scaffolding board 8A for expansion bridged between the longitudinal beams 2A and 2A for expansion, and thus, the assembly work can be performed more safely.

Furthermore, with this method of assembling the scaffolding device 1, it is possible to omit the step of connecting the end portions of the plurality of longitudinal beams 2 and lateral beams 3 respectively to the coupling members 5 at once. Therefore, it becomes less likely to make a mistake in determining as to which of the four insertion holes 50a and 51a provided in the coupling member 5 the longitudinal beam 2 and the lateral beam 3 are to be connected. Therefore, with the above-described method of assembly, a mistake in assembly is less likely to occur, and assembly workability is improved.

Note that the number of times of repeating the steps of bridging the intermediate beam 7A for expansion between the pair of longitudinal beams 2A and 2A for expansion, and bridging the scaffolding board 8A for expansion between the pair of longitudinal beams 2A and 2A for expansion while allowing the scaffolding board 8A for expansion to be supported by at least the bridged intermediate beam 7A for expansion, is the same as the number of intermediate beams 7 to be installed in the frame body 6. Therefore, when N pieces (N is an integer of two or more) of intermediate beams 7 are provided for one frame body 6, this step is performed N times.

Next, the scaffolding device 100 of a second embodiment will be described in detail. Here, portions of the scaffolding device 100 of the second embodiment different from those of the scaffolding device 1 of the first embodiment will be described in detail, and in order to avoid duplication of description, the same members are denoted by the same reference signs and detailed description thereof will be omitted.

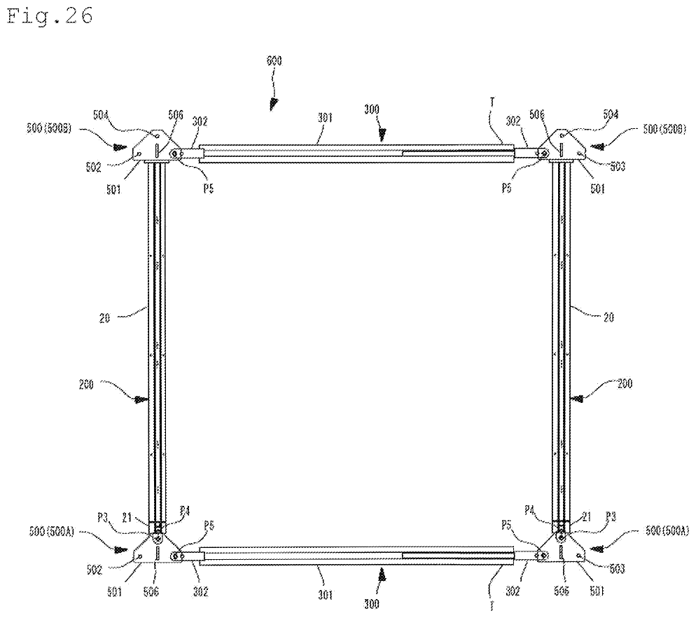

As illustrated in FIG. 26, the scaffolding device 100 according to the second embodiment includes a frame body 600 including a pair of longitudinal beams 200 and 200 disposed along a depth direction (vertical direction in the drawing), a pair of lateral beams 300 and 300 disposed along a width direction (horizontal direction in the drawing), and four coupling members 500 disposed between respective end portions of the longitudinal beams 200 and respective end portions of the lateral beams 300 to rotatably connect the longitudinal beams 200 and the lateral beams 300 on the same plane, three intermediate beams 7 bridged between the longitudinal beams 200 and 200 at a predetermined interval, and four scaffolding boards 8 bridged between the longitudinal beams 200 and 200 and supported by at least one of the intermediate beam 7. In FIG. 26, illustration of the intermediate beams 7 and the scaffolding boards 8 is omitted in order to facilitate understanding of the structure of the frame body 600. In addition, the intermediate beam 7 and the scaffolding board 8 of the second embodiment are the same as the intermediate beam 7 and the scaffolding board 8 in the scaffolding device 1 of the first embodiment.

Hereinafter, among the four coupling members 500, two coupling members 500 disposed on the front-side (the lower side in FIG. 26) in the depth direction of the frame body 600 will be referred to as front-side coupling members 500A, two coupling members 500 disposed on the depth-side (the upper side in FIG. 26) in the depth direction of the frame body 600 will be referred to as depth-side coupling members 500B, and each part of the scaffolding device 100 of the second embodiment will be described.

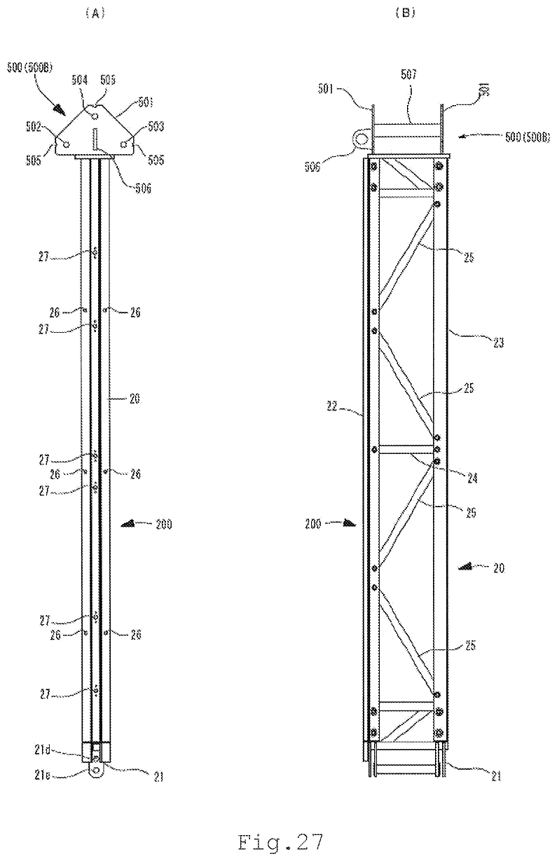

As illustrated in FIG. 27, the coupling member 500 of the present embodiment includes a pair of upper and lower plates 501 and 501, and a tubular connecting portion 507 that connects the upper plate 501 and the lower plate 501. As illustrated in FIGS. 26 and 27(A), each of the plates 501 is a flat plate having a shape formed by chamfering vertexes of an isosceles triangle, and a base side is fixedly connected to one end of the longitudinal beam 200 by welding. Therefore, the front-side coupling member 500A is fixedly attached to one end of the longitudinal beam 200 of the frame body 600 (not illustrated in the drawing) disposed on the front-side, and the depth-side coupling member 500B is fixedly attached to one end of the longitudinal beam 200 of the frame body 600 in the drawing. Note that the method of connecting the longitudinal beam 200 and the coupling member 500 is not limited to welding as long as the longitudinal beam 200 and the coupling member 500 are integrally inseparable.

In addition, as illustrated in FIG. 27(A), each plate 501 is formed with a left hole 502 and a right hole 503 disposed side by side on the left and right, and a front hole 504 disposed between the left hole 502 and the right hole 503 on the depth-side (upper side in the drawing) of the left hole 502 and the right hole 503. The shape of the plate 501 is not particularly limited to the above-described shape, and may be a circle or a quadrangle.

As illustrated in FIG. 27(A), an anti-rotation groove 505 is respectively provided on the outer periphery of each plate 501 at a position facing the left hole 502, the right hole 503, and the front hole 504 as viewed from the center of each plate 501.

Further, as illustrated in FIG. 27, a chain bracket 506 to which a lower end of the chain 9 as a hanging member can be attached is provided at a central position of the upper plate 501 surrounded by the left hole 502, the right hole 503, and the front hole 504.

As illustrated in FIGS. 26 and 27, the longitudinal beam 200 of the present embodiment is different from the longitudinal beam 2 of the first embodiment in that a depth-side coupling member 500B is integrally connected instead of the connecting portion 21 provided at the depth-side end (upper end in the drawing) of the beam body 20, and the other configurations are the same.

Specifically, as illustrated in FIG. 27, the longitudinal beam 200 of the present embodiment includes a beam body 20 and a connecting portion 21 provided at a front-side end (lower end in the drawing) of the beam body 20 and connectable to the front-side coupling member 500A. The connecting portion 21 in the second embodiment corresponds to a first connecting portion described in the claims.

In addition, since the method is the same as the method of connecting the coupling member 5 to the end portion of the longitudinal beam 2 in the first embodiment, although not illustrated in detail, in the present embodiment, the longitudinal beam 200 is connected rotatably in the horizontal direction to the front-side coupling member 500A by inserting a first connecting pin P3 in a state where the first attachment hole 21d provided in the connecting portion 21 and the front hole 504 of the front-side coupling member 500A are allowed to face each other, and the longitudinal beam 200 is non-rotatably fixed to the front-side coupling member 500A fixedly attached to the longitudinal beam 200 in the front-side of the frame body 600 not illustrated in the drawing by inserting an anti-rotation pin P4 in a state where the second attachment hole 21e provided in the connecting portion 21 and the anti-rotation groove 505 facing the front hole 504 of the front-side coupling member 500A are allowed to face each other.

The structures of the first connecting pin P3 and the anti-rotation pin P4 of the present embodiment are the same as the structures of the fixing pin P1 and the anti-rotation pin P2 of the first embodiment, but may be different from the structures of the fixing pin P1 and the anti-rotation pin P2 of the first embodiment.

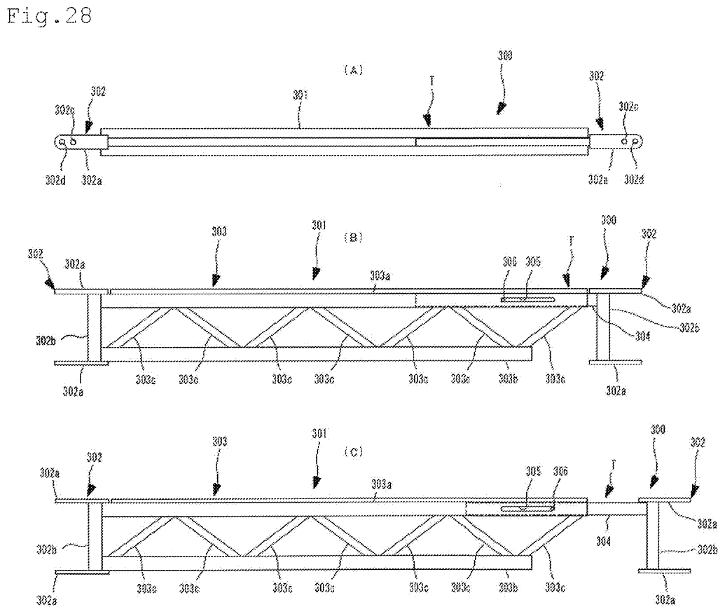

As illustrated in FIGS. 26 and 28, the lateral beam 300 of the present embodiment includes a beam body 301 having an expansion/contraction portion T constituted by an upper chord 303a as an outer tube and a sliding body 404 as an inner tube slidably inserted into the upper chord 303a, and second connecting portions 302 respectively provided at both ends of the beam body 301 in the longitudinal direction and connectable to the coupling members 500.

Specifically, as illustrated in FIG. 28(B), the beam body 301 of the present embodiment includes: a support body 303 having a truss structure including an upper chord 303a and a lower chord 303b having a quadrangular tubular cross section and disposed in parallel to vertically face each other, and a plurality of diagonal bracings 303c diagonally bridged between the upper chord 303a and the lower chord 303b to connect the upper chord 303a and the lower chord 303b; and a sliding body 304 having a quadrangular tubular cross section as an inner tube slidably inserted into the upper chord 301a as an outer tube.

That is, in the present embodiment, the upper chord 301a and the sliding body 304 slidably inserted into the upper chord 301a constitute the expansion/contraction portion T, and as illustrated in FIGS. 28(B) and 28(C), the expansion/contraction portion T can be expanded/contracted to change the axial length of the lateral beam 300 by moving the sliding body 304 in and out of the upper chord 301a.

In the present embodiment, the upper chord 303a of the support body 303 is the outer tube of the expansion/contraction portion T, but the lower chord 303b may be the outer tube of the expansion/contraction portion T. Alternatively, both the upper chord 303a and the lower chord 303b may be configured as outer tubes of the expansion/contraction portion T, and two inner tubes to be inserted into the respective outer tubes may be provided, and these inner tubes may be configured as inner tubes of the expansion/contraction portion T. However, in a case where the number of inner tubes of the expansion/contraction portion T is two, the strength of the expansion/contraction portion T is improved, but the weight of the lateral beam 300 is increased by the increase in the number of inner tubes of the expansion/contraction portion T. The number of outer tubes and inner tubes of the expansion/contraction portion T can be changed in design according to required strength and weight.

In the lateral beam 300 of the present embodiment, the expansion/contraction portion T is provided on one end side of the beam body 301, but the expansion/contraction portion T may be provided in a partway in the beam body 301 in the axial direction.

In the present embodiment, the support body 303 has a truss structure in order to secure the strength of the beam body 301, but the structure of the support body 303 is not limited to the truss structure as long as the required strength is secured.

In addition, the expansion/contraction portion T of the present embodiment includes a detachment prevention means of preventing the sliding body 304 from coming off from the upper chord 303a. Specifically, as illustrated in FIGS. 28(B) and 28(C), the detachment prevention means of the present embodiment includes a long hole 305 formed along the axial direction in the upper chord 303a as the outer tube of the expansion/contraction portion T, and a regulation pin 306 protruding in the radial direction from the outer periphery of the sliding body 304 and to be inserted into the long hole 305. As illustrated in FIG. 28(B), the regulation pin 306 regulates further contraction of the expansion/contraction portion T when abutting on an edge of the long hole 305 on the center side (left side in the drawing) of the upper chord 303a, and as illustrated in FIG. 28(C), regulates further extension of the expansion/contraction portion T when abutting on an edge of the long hole 305 on the distal end side (right side in the drawing) of the upper chord 303a.

Therefore, when such a detachment prevention means is provided, it is possible to set the stretchable length of the expansion/contraction portion T and to prevent the sliding body 304 from coming off from the upper chord 303a during the transportation of the lateral beam 300.

Note that the above-described configuration of the detachment prevention means is an example, and is not limited to the above-described means as long as it is possible to prevent the sliding body 304 from coming off from the upper chord 303a. Therefore, for example, pin holes that can face each other when the expansion/contraction portion T contracts may be provided in each of the upper chord 303a as the outer tube and the sliding body 304 as the inner tube, and a lock pin may be inserted into both the pin holes to prevent the sliding body 304 from coming off. In this way, if the lock pin is inserted into both pin holes only at the time of transportation of the lateral beam 300, the expansion/contraction portion T does not automatically expand/contract at the time of transportation of the lateral beam 300, so that the expansion/contraction portion T does not interfere with the transportation of the lateral beam 300.

Referring back to the previous drawings, as illustrated in FIG. 28, the second connecting portion 302 of the present embodiment includes a pair of upper and lower facing plates 302a and 302a and a tubular connecting body 302b that connects proximal ends of the pair of facing plates 302a and 302a. In each of the facing plates 302a, a first hole 302c disposed on the proximal end side and a second hole 302d disposed on the distal end side are provided side by side along the longitudinal direction of the beam body 301 of the lateral beam 300.

As illustrated in FIG. 28, the connecting bodies 302b of the second connecting portions 302 are respectively fixed to the end of the opposite side of the sliding body (the left end in FIG. 28(B)) of the support body 303 and the end of the opposite side of the support body (the right end in FIG. 28(B)) of the sliding body 304, so that the second connecting portions 302 are provided at both ends of the beam body 301.

Among the two coupling members 500 and 500 facing each other in the width direction of the frame body 600, in a state where the first hole 302c of each of the second connecting portions 302 is allowed to face the right hole 503 of the left coupling member 500 and the left hole 502 of the right coupling member 500, respectively, a second connecting pin P5 is inserted into the left hole 502 and the right hole 503 and the first hole 302c of each of the second connecting portions 302, whereby the lateral beam 300 is connected rotatably in the horizontal direction with respect to the coupling members 500 and 500 facing each other in the width direction of the frame body 600. The structure of the second connecting pin P5 of the present embodiment is the same as that of the fixing pin P1 of the first embodiment, but may be different.

In addition, the structures and the numbers of the intermediate beams 7 and the scaffolding boards 8 bridged between the longitudinal beams 200 and 200 are the same as those of the first embodiment, and thus the description thereof will be omitted.

Next, a method of assembling the scaffolding device 100 of the second embodiment will be described in detail. Here, the frame body 600, the intermediate beams 7 bridged between the longitudinal beams 200 and 200 of the frame body 600, and the scaffolding boards 8 will be referred to as one scaffolding unit A10 for description.

First, in the same manner as the first embodiment, the scaffolding device 100 to which a plurality of scaffolding units A10 are connected in the depth direction and the width direction is assembled on the ground. Then, the scaffolding device 100 assembled on the ground is suspended from a building structure or a construction structure via a chain 9 (not illustrated).

Next, in a state where the first attachment holes 21d of the connecting portions 21 of the respective longitudinal beams 200 are allowed to face the respective front holes 504 of the front-side coupling members 500A, which are the coupling members 500 connected to the depth-side ends of the longitudinal beams 200 in the scaffolding unit A10 (hereinafter, referred to as “existing scaffolding unit”) of the scaffolding device 100 suspended on the building structure or the construction structure, the first connecting pins P3 are inserted into the respective first attachment holes 21d and the front holes 504, and the respective longitudinal beams 200 are connected to the respective front-side coupling members 500A so as to be rotatable in the horizontal direction.

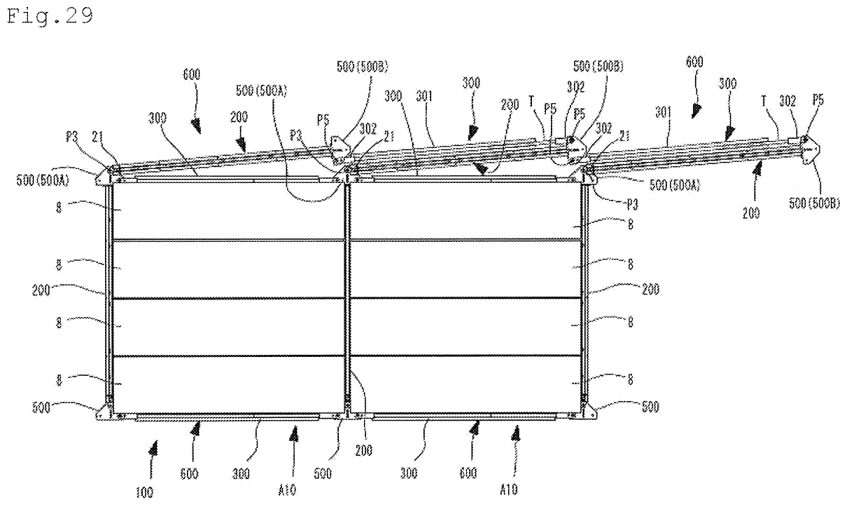

Thereafter, as illustrated in FIG. 29, the depth-side end of each of the longitudinal beams 200 is pulled toward the front-side, in a state where the first hole 302c of the second connecting portion 302 of the lateral beam 300 are allowed to face the right hole 503 of the depth-side coupling member 500B located on the left side and the left hole 502 of the depth-side coupling member 500B located on the right side among the depth-side coupling members 500B adjacent in the width direction, the second connecting pin P5 is inserted into each of the left hole 502 and the right hole 503 and the first hole 302c of the second connecting portion 302 so that each end portion of the lateral beam 300 is connected to each of the depth-side coupling members 500B and 500B so as to be rotatable in the horizontal direction. In this way, as illustrated in FIG. 29, the plurality of frame bodies 600 are connected to the front-side coupling member 500A in the folded posture.

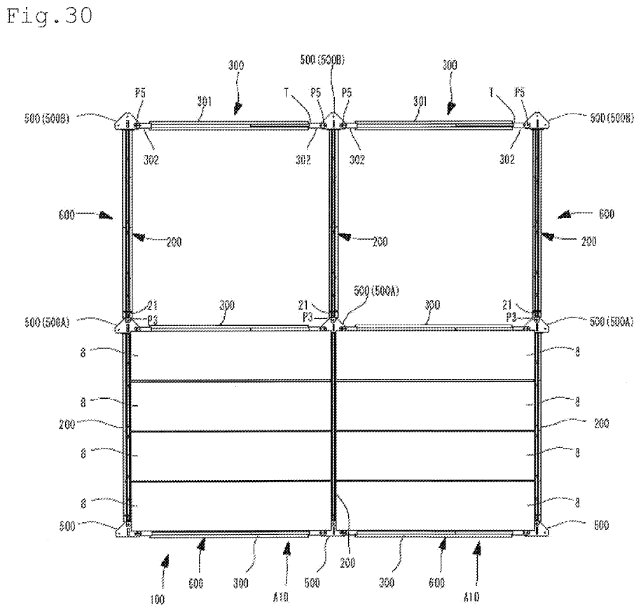

Next, as illustrated in FIG. 30, the longitudinal beams 200 are rotated in the horizontal direction with respect to the front-side coupling member 500A until the longitudinal beams 200 and the lateral beams 300 are respectively disposed in parallel with each other, and the postures of the plurality of frame bodies 600 are changed from the folded posture to the unfolded posture.

Here, the distance between the depth-side coupling members 500B and 500B adjacent in the width direction of the frame body 600 is the closest when the frame body 600 is in the unfolded posture, and is the farthest when the frame body 600 is in the folded posture. However, in the present embodiment, since the lateral beam 300 includes the expansion/contraction portion T, the expansion/contraction portion T is maximally extended when the frame body 600 is in the folded posture as illustrated in FIG. 29, and the expansion/contraction portion T is maximally contracted when the frame body 600 is in the unfolded posture as illustrated in FIG. 30. That is, it is possible to cope with the change in the distance between the depth-side coupling members 500B and 500B adjacent in the width direction of the frame body 600 by expanding and contracting the expansion/contraction portion T to change the axial length of the lateral beam 300.

Therefore, with the scaffolding device 100 of the present embodiment, even if each depth-side coupling member 500B is integrally connected to each depth-side end of the longitudinal beam 200, the plurality of frame bodies 600 can be assembled at once by connecting the plurality of frame bodies 600 to the front-side coupling members 500A in the folded posture and then changing the posture of the plurality of frame bodies 600 to the unfolded posture.

Thereafter, the anti-rotation pin P4 is inserted into the second attachment hole 21e of the connecting portion 21 provided at the front-side end of each longitudinal beam 200, and each longitudinal beam 200 is non-rotatably fixed to the front-side coupling member 500A.

In the second embodiment, since the depth-side coupling member 500B is integrally connected to the depth-side end of the longitudinal beam 200, when the longitudinal beam 200 is non-rotatably fixed to the front-side coupling member 500A, the lateral beam 300 is also automatically made non-rotatable with respect to the depth-side coupling member 500B. Therefore, in the second embodiment, an anti-rotation pin is not required for non-rotatably connecting the lateral beam 300 to the depth-side coupling member 500B.

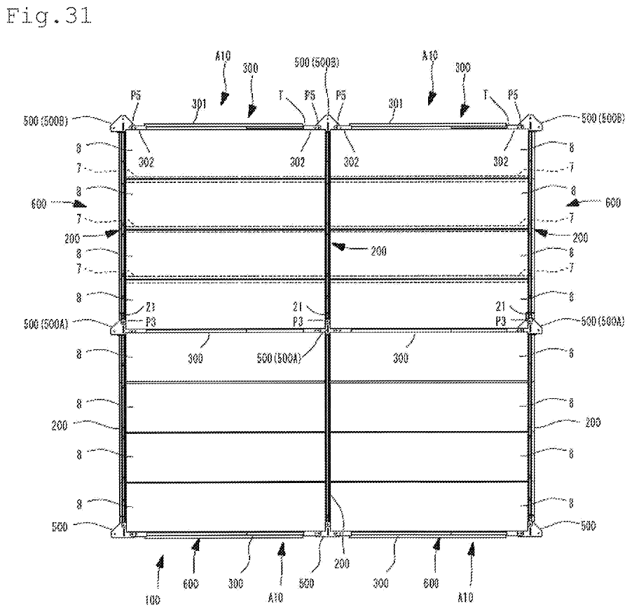

Finally, a step of bridging the intermediate beams 7 between the longitudinal beams 200 and 200 adjacent in the width direction of the frame body 600 in order from the front-side in the depth direction and a step of bridging the scaffolding boards 8 between the longitudinal beams 200 and 200 while allowing the scaffolding boards 8 to be supported by the lateral beam 300 and the intermediate beam 7 or the intermediate beams 7 and 7 adjacent in the depth direction are repeated as many as the number of intermediate beams 7 installed in one frame body 600. As a result, as illustrated in FIG. 31, the scaffolding unit A10 for expansion is connected to the existing scaffolding unit A10 of the scaffolding device 100.

By repeating the above procedure in the width direction or the depth direction, the scaffolding device 100 of the present embodiment can expand the floor board area to a freely-selected position in a state of being suspended from a building structure or a construction structure.

However, the method of assembling the scaffolding device 100 is not limited to the above method, and may be a method in which, as in the scaffolding device 1 of the first embodiment, the steps of disposing a pair of longitudinal beams 200 in parallel along the depth direction, then bridging intermediate beams 7 between longitudinal beams 200 and 200, and bridging scaffolding boards 8 between the longitudinal beams 200 and 200 while allowing each scaffolding board 8 to be supported at least by the bridged intermediate beam 7, are repeated in order from the front-side by the same number as the number of intermediate beams 7 to be installed in one frame body 600, and after bridging the lateral beams 300 to the depth-side ends of the longitudinal beams 200, finally the scaffolding board 8 is bridged between the longitudinal beams 200 and 200 while allowing the scaffolding board 8 to be supported by the lateral beam 300 on the depth-side.

As described above, in the scaffolding device 100 of the present embodiment, the coupling member 500 is formed with the left hole 502 and the right hole 503 disposed side by side on the left and right, and the front hole 504 disposed on the depth-side of the left hole 502 and the right hole 503, the longitudinal beam 200 is integrally connected with the depth-side coupling member 500B at the depth-side end, and provided with, at the front-side end, the connecting portion 21 (first connecting portion) having the hole (first attachment hole 21d), and the lateral beam 300 is formed with the beam body 301 having the expansion/contraction portion T constituted by the outer tube (upper chord 301a) and the inner tube (sliding body 304) slidably inserted into the outer tube (upper chord 301a), and the second connecting portions 302 each provided at both ends in the longitudinal direction of the beam body 301 and having a hole (first hole 302c). In a state where the hole (first attachment hole 21d) of the connecting portion 21 and the front hole 504 of the front-side coupling member 500A are allowed to face each other, the longitudinal beam 200 is connected to the front-side coupling member 500A so as to be rotatable in the horizontal direction by the first connecting pin P3 inserted into the hole (first attachment holes 21d) of the connecting portion 21 and the front hole 504 of the front-side coupling member 500A. In a state where, in the two depth-side coupling members 500B facing each other in the width direction of the frame body 600, the right hole 503 of the depth-side coupling member 500B on the left side and the left hole 502 of the depth-side coupling member 500B on the right side are respectively allowed to face the holes (first holes 302c) of the second connecting portions 302, each end portion of the lateral beam 300 is connected to each of the depth-side coupling members 500B so as to be rotatable in the horizontal direction by the second connecting pins P5 respectively inserted through the left hole 502 and the right hole 503 into the hole (first hole 302c) of each of the second connecting portions 302.

With this configuration, since the depth-side coupling member 500B is integrally connected to the depth-side end of the longitudinal beam 200, it is not necessary for a worker to perform an operation of connecting the depth-side coupling member 500B to each longitudinal beam 200 when assembling the scaffolding device 100. Therefore, the assembly work of the scaffolding device 100 is facilitated, and the time required for assembling the scaffolding device 100 can be shortened.

Furthermore, in the scaffolding device 100 of the present embodiment, the lateral beam 300 includes the expansion/contraction portion T. Therefore, with the scaffolding device 100 of the present embodiment, even if each depth-side coupling member 500B is integrally connected to each depth-side end of the longitudinal beam 200, when the posture of the frame body 600 is changed from the folded posture to the unfolded posture, the change in the distance between the depth-side coupling members 500B and 500B adjacent to each other in the width direction of the frame body 600 can be coped with by changing the axial length of the lateral beams 300 by expanding and contracting the expansion/contraction portions T. Therefore, in the present embodiment, the plurality of frame bodies 600 can be assembled at once by the above-described method of connecting the plurality of frame bodies 600 to the front-side coupling members 500A in the folded posture and then changing the posture of the plurality of frame bodies 600 to the unfolded posture.

Also in the scaffolding device 100 of the present embodiment, in the same manner as the scaffolding device 1 of the first embodiment, since the number of intermediate beams 7 bridged between the longitudinal beams 200 and 200 is two or more, and the number of scaffolding boards 8 to be installed in the frame body 600 is at least three or more, the width of the scaffolding board 8 is narrowed and the weight per scaffolding board 8 can be reduced as compared with the case where the number of scaffolding boards 8 to be installed in the frame body 600 is two or less as in the related art.

Furthermore, since the width of the scaffolding board 8 is narrowed, the width between the intermediate beams 7 and 7 supporting the scaffolding board 8 is also narrowed. Therefore, at the time of assembling the scaffolding device 100, the worker can perform the work of bridging the next intermediate beam 7 and the scaffolding board 8 between the longitudinal beams 200 and 200 from the scaffolding board 8 bridged between the longitudinal beams 200 and 200 without largely leaning out of the scaffolding board 8. Therefore, the assembly work of the scaffolding device 100 can be performed more safely.

Note that in the scaffolding device 100 of the second embodiment, the installing number of the intermediate beams 7 may be less than two, and the number of scaffolding boards 8 to be installed in the frame body 600 may be two or less.

Next, a first modification example of the scaffolding device 100 of the second embodiment will be described. Here, portions of a scaffolding device 100A of the first modification example different from those of the scaffolding device 100 of the second embodiment will be described in detail, and in order to avoid duplication of description, the same members are denoted by the same reference signs and detailed description thereof will be omitted.

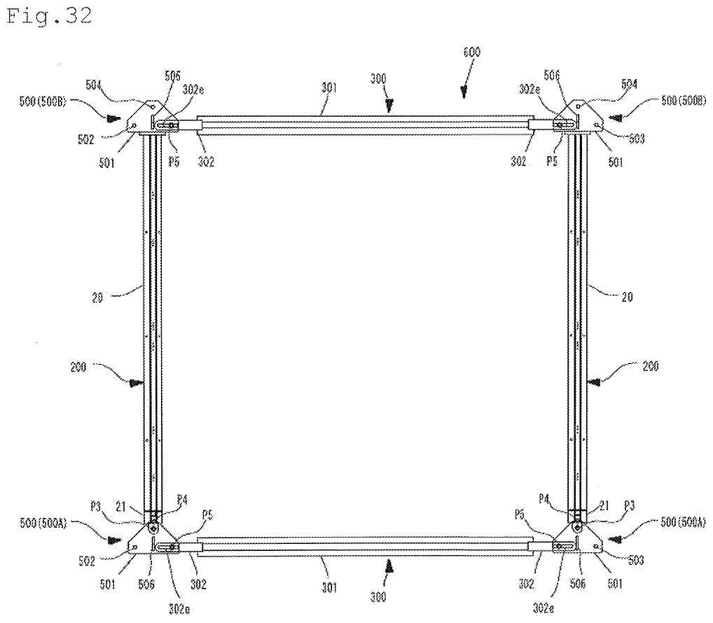

As illustrated in FIG. 32, the scaffolding device 100A of the first modification example is different from the second embodiment in that the expansion/contraction portion T provided in the lateral beam 300 is omitted, and instead of the first hole 302c and the second hole 302d of the second connecting portion 302 provided at both ends in the longitudinal direction of the lateral beam 300, a long hole 302e that is a hole having a long length in the direction along the axial direction of the lateral beam 300 is provided. In FIG. 32, illustration of the intermediate beams 7 and the scaffolding boards 8 is omitted in order to facilitate understanding of the structure of the frame body 600 of the scaffolding device 100A of the first modification example.

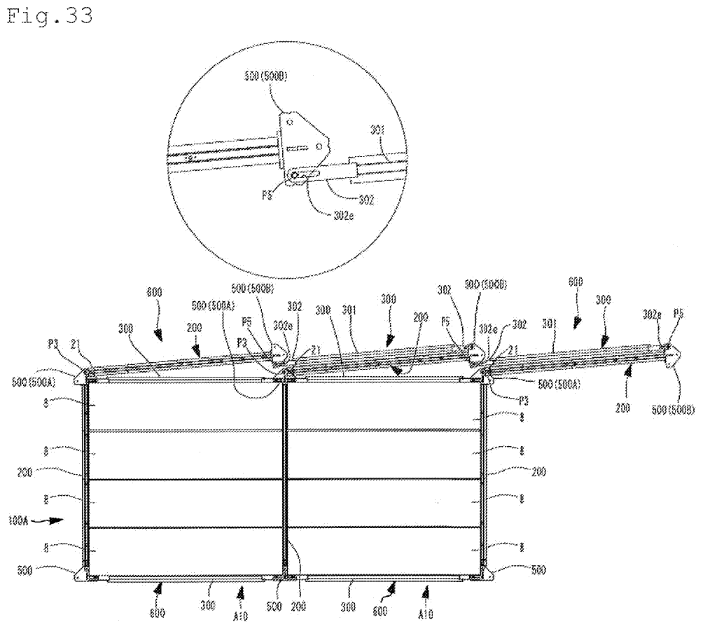

In the scaffolding device 100A of the first modification example, as illustrated in FIG. 33, in a state where the frame body 600 is in the folded posture and the distance between the depth-side coupling members 500B and 500B adjacent in the width direction of the frame body 600 is the farthest, each second connecting pin P5 connecting each end portion of the lateral beam 300 and each depth-side coupling member 500B abut on the distal end side edges of each long hole 302e.

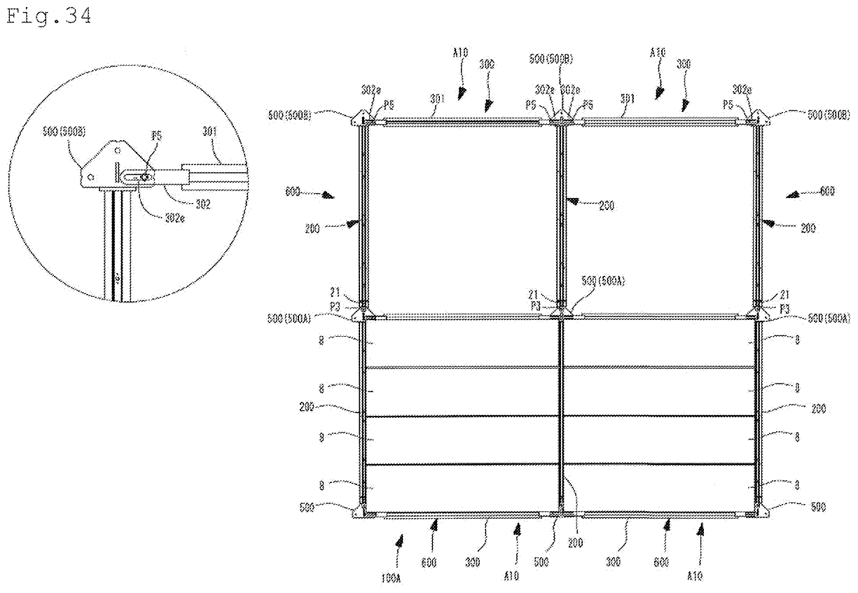

As illustrated in FIG. 34, in a state where the frame body 600 is in the unfolded posture and the distance between the depth-side coupling members 500B and 500B adjacent in the width direction of the frame body 600 is the closest, each second connecting pin P5 connecting each end portion of the lateral beam 300 and each depth-side coupling member 500B is located near the proximal end side edge of each long hole 302e.

Therefore, in the scaffolding device 100A of the first modification example, when the posture of the frame body 600 is changed from the folded posture to the unfolded posture, it is possible to cope with the change in the distance between the depth-side coupling members 500B and 500B adjacent in the width direction of the frame body 600 by sliding each second connecting pin P5 along the longitudinal direction of each long hole 302e.

Therefore, also in the scaffolding device 100A of the first modification example, even if the depth-side coupling member 500B is integrally connected to the depth-side end of the longitudinal beam 200, the plurality of frame bodies 600 can be assembled at once by a method of connecting the plurality of frame bodies 600 to the front-side coupling members 500A in the folded posture and then changing the posture of the plurality of frame bodies 600 to the unfolded posture.

In the first modification example, the long hole 302e is set in such a length that in a case where the frame body 600 is in the folded posture, each second connecting pin P5 abuts on the distal end side edge of each long hole 302e, and in a case where the frame body 600 is in the unfolded state, each second connecting pin P5 locates near the proximal end side edge of each long hole 302e. However, it is sufficient as long as the long hole 302e is set in the length that allows the movement of the second connecting pin P5 at least when the posture of the frame body 600 is changed from the folded posture to the unfolded posture.

Also in the scaffolding device 100A of the first modification example, in the same manner as the scaffolding device 100 of the second embodiment, since the depth-side coupling member 500B is integrally connected to the depth-side end of the longitudinal beam 200, it is not necessary for a worker to perform an operation of connecting the depth-side coupling member 500B to each longitudinal beam 200 when assembling the scaffolding device 100. Therefore, the assembly work of the scaffolding device 100A is facilitated, and the time required for assembling the scaffolding device 100A can be shortened.

Next, a second modification example of the scaffolding device 100 of the second embodiment will be described. Here, portions of a scaffolding device 100B of the second modification example different from those of the scaffolding device 100 of the second embodiment will be described in detail, and in order to avoid duplication of description, the same members are denoted by the same reference signs and detailed description thereof will be omitted.

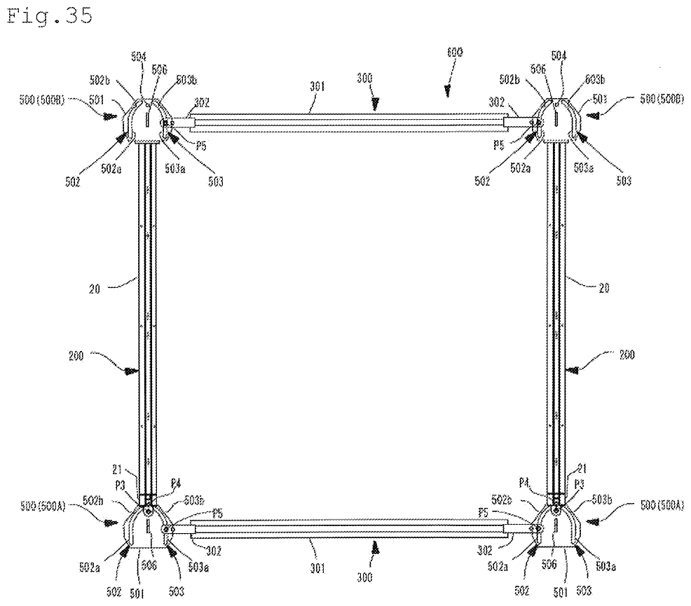

As illustrated in FIG. 35, in the scaffolding device 100B of the second modification example, the expansion/contraction portion T provided in the lateral beam 300 is omitted, and the left hole 502 and the right hole 503 formed in the coupling member 500 are different from those of the second embodiment in having straight-line portions 502a and 503a provided along the depth direction and curved portions 502b and 503b connected to the depth-side ends of the straight-line portions 502a and 503a and curved inward. In FIG. 35, illustration of the intermediate beams 7 and the scaffolding boards 8 is omitted in order to facilitate understanding of the structure of the frame body 600 of the scaffolding device 100B of the second modification example.

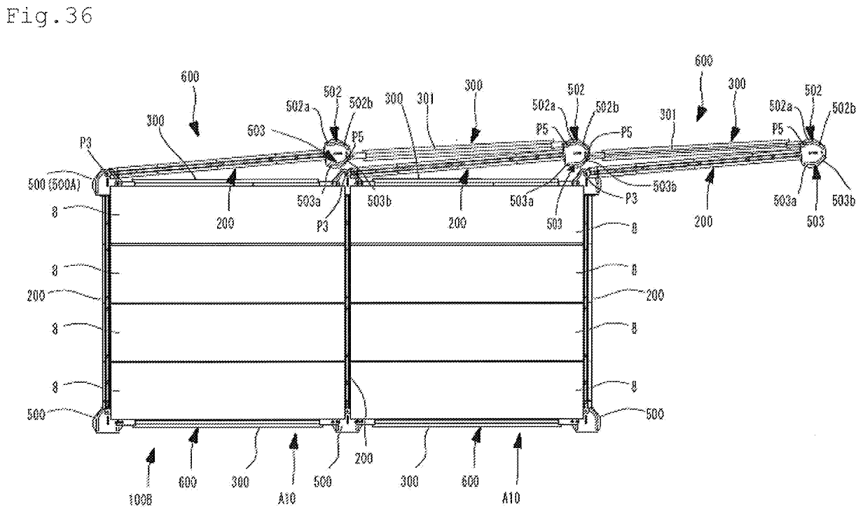

In the scaffolding device 100B of the second modification example, as illustrated in FIG. 36, in a state where the frame body 600 is in a folded posture in which the longitudinal beam 200 is folded to the right side in the drawing and the distance between the depth-side coupling members 500B and 500B adjacent in the width direction of the frame body 600 is the farthest, the second connecting pin P5 connecting the depth-side coupling member 500B on the left side in the drawing and the left end of the lateral beam 300 is located at the depth-side end in the curved portion 503b of the right hole 503 of the depth-side coupling member 500B on the left side, and the second connecting pin P5 connecting the depth-side coupling member 500B on the right side in the drawing and the right end of the lateral beam 300 is located at the front-side end in the straight-line portion 502a of the left hole 502 of the depth-side coupling member 500B on the right side.

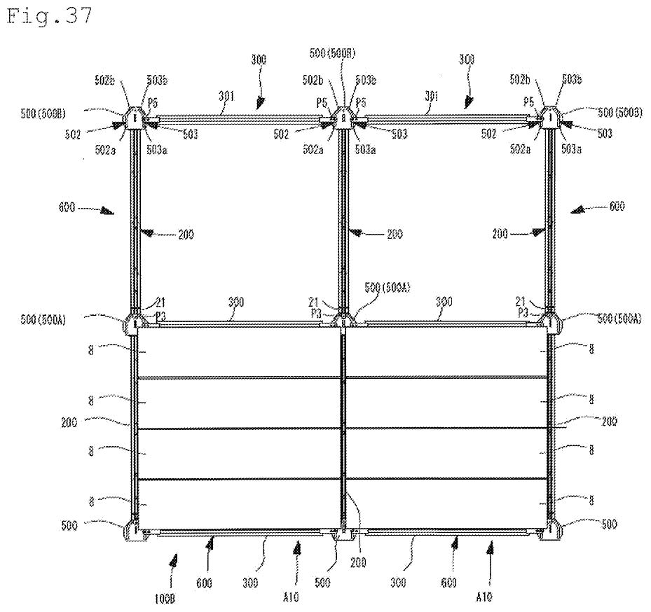

In the drawing, the frame body 600 is illustrated in a folded posture while being folded to the right side, but the frame body 600 may be folded to the left side. In this case, the second connecting pin P5 connecting the depth-side coupling member 500B on the left side in the drawing and the left end of the lateral beam 300 is located at the front-side end in the straight-line portion 503a of the right hole 503 of the depth-side coupling member 500B on the left side, and the second connecting pin P5 connecting the depth-side coupling member 500B on the right side in the drawing and the right end of the lateral beam 300 is located at the depth-side end in the curved portion 502b of the left hole 502 of the depth-side coupling member 500B on the right side. As illustrated in FIG. 37, when the frame body 600 is in the unfolded posture and the distance between the depth-side coupling members 500B and 500B adjacent to each other in the width direction of the frame body 600 is the shortest, the second connecting pins P5 respectively connecting the end portions of the lateral beams 300 to the left and right depth-side coupling members 500B and 500B are respectively located in the straight-line portion 503a of the right hole 503 of the depth-side coupling member 500B on the left side in the drawing and in the straight-line portion 502a of the left hole 502 of the depth-side coupling member 500B on the right side in the drawing.

As described above, in the scaffolding device 100B of the second modification example, the right hole 503 of the depth-side coupling member 500B on the left side and the left hole 502 of the depth-side coupling member 500B on the right side are shaped along the movement locus of the second connecting pin P5 when the posture of the frame body 600 is changed from the folded posture to the unfolded posture.

Therefore, when the posture of the frame body 600 is changed from the folded posture to the unfolded posture, even if the distance between the depth-side coupling members 500B and 500B adjacent in the width direction of the frame body 600 is changed, each of the second connecting pins P5 respectively slides in the right hole 503 of the depth-side coupling member 500B on the left side and in the left hole 502 of the depth-side coupling member 500B on the right side according to the change in the distance between the depth-side coupling members 500B and 500B to change the position.

Therefore, also in the scaffolding device 100B of the second modification example, even if each depth-side coupling member 500B is integrally connected to each depth-side end of the longitudinal beam 200, the plurality of frame bodies 600 can be assembled at once by a method of connecting the plurality of frame bodies 600 to the front-side coupling members 500A in the folded posture and then changing the posture of the plurality of frame bodies 600 to the unfolded posture.

Also in the scaffolding device 100B of the second modification example, in the same manner as the scaffolding device 100 of the second embodiment, since each depth-side coupling member 500B is integrally connected to each depth-side end of the longitudinal beam 200, it is not necessary for a worker to perform an operation of connecting the depth-side coupling member 500B to each longitudinal beam 200 when assembling the scaffolding device 100. Therefore, the assembly work of the scaffolding device 100B is facilitated, and the time required for assembling the scaffolding device 100B can be shortened.

Hereinabove, preferred embodiments of the present invention are described in detail; however, it goes without saying that alterations, modifications, and changes can be made without departing from the scope of claims.

The present application claims priority based on Japanese Patent Application No. 2021-154863 filed with the Japan Patent Office on Sep. 22, 2021, and the entire contents of this application are incorporated into the present specification by reference.

### REFERENCE SIGNS LIST

1, 100, 100A, 100B scaffolding device
2, 200 longitudinal beam
3, 300 lateral beam
5, 500, 500A, 500B coupling member
6, 600 frame body
7 intermediate beam
8 scaffolding board
9 chain (hanging member)
11 bracket
20, 30, 301 beam body
21, 31 connecting portion (first connecting portion)
21c, 31c connecting piece
21d, 31d first attachment hole (hole)
21e, 31e second attachment hole
22, 32 upper chord
22a, 32a scaffolding board support portion
22b, 32b positioning piece
23, 33 lower chord
24, 34 strut
25, 35 diagonal bracing
50 upper plate
51 lower plate
50a, 51a insertion hole
50b, 51b anti-rotation groove
52 connecting portion
301a upper chord (outer tube)
302 second connecting portion
302c first hole (hole)
302e long hole (hole)
304 sliding body (inner tube)
502 left hole
503 right hole
502a, 503a straight-line portion
502b, 503b curved portion
504 front hole
P1 fixing pin
P2, P4 anti-rotation pin
P3 first connecting pin
P5 second connecting pin
Pa upper protrusion
Pb lower protrusion
T expansion/contraction portion

1. A scaffolding device comprising:
a frame body including a pair of longitudinal beams, a pair of lateral beams, and four coupling members disposed between respective end portions of the longitudinal beams and respective end portions of the lateral beams and configured to rotatably connect the longitudinal beams and the lateral beams on a same plane;
two or more intermediate beams bridged between the longitudinal beams at a predetermined interval; and
scaffolding boards bridged between the longitudinal beams and supported by at least one of the intermediate beams, the number of the scaffolding boards being larger than the installing number of the intermediate beams by one, wherein
the longitudinal beams and the lateral beams each include a beam body and a connecting portion that is detachably connected to both ends in a longitudinal direction of the beam body and is capable of connecting the beam body to the coupling member,
the beam body is formed of a material having a mass per unit volume smaller than a mass of the connecting portion, and
the connecting portion is formed of a material having higher rigidity than rigidity of the beam body.

2. A scaffolding device comprising:
a frame body including a pair of longitudinal beams, a pair of lateral beams, and four coupling members disposed between respective end portions of the longitudinal beams and respective end portions of the lateral beams and rotatably connecting the longitudinal beams and the lateral beams on a same plane;
two or more intermediate beams bridged between the longitudinal beams at a predetermined interval; and
scaffolding boards bridged between the longitudinal beams and supported by at least one of the intermediate beams, the number of the scaffolding boards being larger than the installing number of the intermediate beams by one; and
a bracket that is connected to the longitudinal beam or the lateral beam and is attachable to a hanging member that hangs the longitudinal beam or the lateral beam, wherein
the longitudinal beam and the lateral beam each include a beam body and connecting portions to be respectively connected to both ends of the beam body in a longitudinal direction and capable of connecting the beam body to the coupling member,
an upper chord constituting an upper portion of the beam body includes a scaffolding board support portion in a flat plate shape extending along an axial direction of the beam body so as to support the scaffolding board, and a pair of positioning pieces standing upright from an upper surface side of the scaffolding board support portion and facing each other so as to regulate horizontal movement of the scaffolding board supported by the scaffolding board support portion,
the bracket includes a bottom plate connected between the positioning pieces in the scaffolding board support portion, a pair of supporting pieces protruding from an upper portion of the bottom plate and facing each other, a pair of rotating pieces to be rotatably connected to the pair of supporting pieces, and a hanging member holding portion fixed between the rotating pieces and capable of holding the hanging member, and
a width of the bracket is narrower than a width between two scaffolding boards placed on the scaffolding board support portions with the pair of positioning pieces interposed therebetween.

3. A scaffolding device comprising:
a frame body including a pair of longitudinal beams, a pair of lateral beams, and four coupling members disposed between respective end portions of the longitudinal beams and respective end portions of the lateral beams and rotatably connecting the longitudinal beams and the lateral beams on a same plane;
two or more intermediate beams bridged between the longitudinal beams at a predetermined interval; and
scaffolding boards bridged between the longitudinal beams and supported by at least one of the intermediate beams, the number of the scaffolding boards being larger than the installing number of the intermediate beams by one, wherein
the longitudinal beams and the lateral beams each include a beam body and connecting portions connected to both ends of the beam body in a longitudinal direction and capable of connecting the beam body to the coupling member,
the coupling member includes a pair of upper and lower plates disposed in parallel, and a connecting portion that connects the plates to each other,
the plates each includes four insertion holes disposed at equal intervals on a same circumference and facing each other, and four anti-rotation grooves provided on an outer periphery of the plate at positions facing the insertion holes when viewed from a center of the plate,
the connecting portion includes a pair of upper and lower connecting pieces protruding from each end portion of the beam body along an axial direction,
each of the connecting pieces includes first attachment holes opposed to each other and a second attachment hole disposed at a position opposed to the anti-rotation groove in a state where the first attachment hole is opposed to any one of the insertion holes,
the anti-anti-rotation groove provided in the lower plate is formed shallower than the anti-rotation groove provided in the upper plate,
the coupling member is rotatably connected to the longitudinal beam or the lateral beam by a fixing pin to be inserted into the first attachment hole and the insertion hole in a state where the first attachment hole provided in the connecting portion and the insertion hole provided in the coupling member are allowed to face each other, and
the coupling member is fixed to the longitudinal beam or the lateral beam in a non-rotatable state by an anti-rotation pin to be inserted into the second attachment hole and the anti-rotation groove in a state where the second attachment hole provided in the connecting portion and the anti-rotation groove provided on an outer periphery of the coupling member are allowed to face each other.

4. A scaffolding device comprising:
a frame body including a pair of longitudinal beams, a pair of lateral beams, and four coupling members disposed between respective end portions of the longitudinal beams and respective end portions of the lateral beams and rotatably connecting the longitudinal beams and the lateral beams on a same plane;
two or more intermediate beams bridged between the longitudinal beams at a predetermined interval; and
scaffolding boards bridged between the longitudinal beams and supported by at least one of the intermediate beams, the number of the scaffolding boards being larger than the installing number of the intermediate beams by one, wherein
among the coupling members, two of the coupling members disposed on a front-side in a depth direction of the frame body are set as front-side coupling members, and two of the coupling members disposed on a depth-side in the depth direction of the frame body are set as depth-side coupling members,
a left hole and a right hole disposed side by side in a left-right direction, and a front hole disposed on a depth-side of the left hole and the right hole are formed in the coupling member,
the longitudinal beam is integrally connected with the depth-side coupling member at a depth-side end, and provided with, at a front-side end, a first connecting portion having a hole,
the lateral beam includes a beam body having an expansion/contraction portion constituted by an outer tube and an inner tube to be slidably inserted into the outer tube, and second connecting portions each provided at both ends in a longitudinal direction of the beam body and have a hole,
in a state where the hole of the first connecting portion and the front hole of the front-side coupling member are allowed to face each other, the longitudinal beam is connected to the front-side coupling member so as to be rotatable in a horizontal direction by a first connecting pin to be inserted into the hole of the first connecting portion and the front hole of the front-side coupling member, and
in a state where, in the two of the depth-side coupling members facing each other in a width direction of the frame body, the right hole of the depth-side coupling member on the left side and the left hole of the depth-side coupling member on the right side are respectively allowed to face the holes of the second connecting portions, each end portion of the lateral beam is connected to each of the depth-side coupling members so as to be rotatable in the horizontal direction by second connecting pins respectively inserted through the left hole and the right hole into the hole of each of the second connecting portions.

5. A scaffolding device comprising:
a frame body including a pair of longitudinal beams, a pair of lateral beams, and four coupling members disposed between respective end portions of the longitudinal beams and respective end portions of the lateral beams and rotatably connecting the longitudinal beams and the lateral beams on a same plane;
two or more intermediate beams bridged between the longitudinal beams at a predetermined interval; and
scaffolding boards bridged between the longitudinal beams and supported by at least one of the intermediate beams, the number of the scaffolding boards being larger than the installing number of the intermediate beams by one, wherein
among the coupling members, two of the coupling members disposed on a front-side in a depth direction of the frame body are set as front-side coupling members, and two of the coupling members disposed on a depth-side in the depth direction of the frame body are set as depth-side coupling members,
a left hole and a right hole disposed side by side in a left-right direction, and a front hole disposed on a depth-side of the left hole and the right hole are formed in the coupling member,
the longitudinal beam is integrally connected with the depth-side coupling member at a depth-side end, and provided with, at a front-side end, a first connecting portion having a hole,
a second connecting portion including a hole having a long length in a direction along an axial direction of the lateral beam is provided at each of both ends in a longitudinal direction of the lateral beam,
in a state where the hole of the first connecting portion and the front hole of the front-side coupling member are allowed to face each other, the longitudinal beam is connected to the front-side coupling member so as to be rotatable in the horizontal direction by a first connecting pin to be inserted into the hole of the first connecting portion and the front hole of the front-side coupling member,
in a state where, in the two of the depth-side coupling members facing each other in a width direction of the frame body, the right hole of the depth-side coupling member on the left side and the left hole of the depth-side coupling member on the right side are respectively allowed to face the holes of the second connecting portions, each end portion of the lateral beam is connected to each of the depth-side coupling members so as to be rotatable in the horizontal direction by second connecting pins respectively inserted through the left hole and the right hole into the hole of each of the second connecting portions, and
the second connecting pin is slidable along a longitudinal direction of the hole of the second connecting portion.

6. A scaffolding device comprising:
a frame body including a pair of longitudinal beams, a pair of lateral beams, and four coupling members disposed between respective end portions of the longitudinal beams and respective end portions of the lateral beams and rotatably connecting the longitudinal beams and the lateral beams on a same plane;
two or more intermediate beams bridged between the longitudinal beams at a predetermined interval; and
scaffolding boards bridged between the longitudinal beams and supported by at least one of the intermediate beams, the number of the scaffolding boards being larger than the installing number of the intermediate beams by one, wherein
among the coup ing members, two of the coupling members disposed on a front-side in a depth direction of the frame body are set as front-side coupling members, and two of the coupling members disposed on a depth-side in the depth direction of the frame body are set as depth-side coupling members,
a left hole and a right hole disposed side by side in the left-right direction, and a front hole arranged on a depth-side of the left hole and the right hole are formed in the coupling member,
each of the left hole and the right hole includes a straight-line portion along a depth direction and a curved portion continuous with a depth-side end of the straight-line portion and curved inward,
the longitudinal beam is integrally connected with the depth-side coupling member at the depth-side end, and provided with, at the front-side end, a first connecting portion having a hole,
a second connecting portion including a hole is provided at each of both ends in a longitudinal direction of the lateral beam,
in a state where the hole of the first connecting portion and the front hole of the front-side coupling member are allowed to face each other, the longitudinal beam is connected to the front-side coupling member so as to be rotatable in the horizontal direction by a first connecting pin to be inserted into the hole of the first connecting portion and the front hole of the front-side coupling member, and
in a state where, in the two of the depth-side coupling members facing each other in a width direction of the frame body, the right hole of the depth-side coupling member on the left side and the left hole of the depth-side coupling member on the right side are respectively allowed to face the holes of the second connecting portions, each end portion of the lateral beam is connected to each of the depth-side coupling members so as to be rotatable in the horizontal direction by second connecting pins respectively inserted through the left hole and the right hole into the hole of each of the second connecting portions.

7. The scaffolding device according to claim 1, wherein
in a state where a first attachment hole provided in the connecting portion and an insertion hole provided in the coupling member are allowed to face each other, the coupling member is rotatably connected to the longitudinal beam or the lateral beam by a fixing pin to be inserted into the first attachment hole and the insertion hole,
in a state where the second attachment hole provided in the connecting portion and an anti-rotation groove provided on an outer periphery of the coupling member are allowed to face each other, the coupling member is fixed to the longitudinal beam or the lateral beam in a non-rotatable state by an anti-rotation pin to be inserted into the second attachment hole and the anti-rotation groove, and
the fixing pin and the anti-rotation pin each include two holes that penetrate upper ends of the fixing pin and the anti-rotation pin in a radial direction and are provided vertically in line in a direction intersecting each other, and two protrusions that are inserted into and fixed to the two holes, respectively.

8. The scaffolding device according to claim 1, wherein
the beam body includes an upper chord and a lower chord that are made of aluminum and disposed in parallel to vertically face each other, and at least one strut and a plurality of diagonal bracings that are bridged between the upper chord and the lower chord so as to connect the upper chord and the lower chord, and
the upper chord, the lower chord, the strut, and the diagonal bracings are connected to each other by bolts and nuts in a detachable manner.

9. The scaffolding device according to claim 1, comprising
an auxiliary beam to be bridged so as to be in parallel with the longitudinal beams and to support the scaffolding board, between the lateral beam and the intermediate beam facing each other and between the intermediate beams facing each other.

10. A method of assembling a scaffolding device that comprises:
a frame body including a pair of longitudinal beams, a pair of lateral beams, and four coup ling members disposed between respective end portions of the longitudinal beams and respective end portions of the lateral beams and configured to rotatably connect the longitudinal beams and the lateral beams on a same plane;
two or more intermediate beams bridged between the longitudinal beams at a predetermined interval; and
scaffolding boards bridged between the longitudinal beams and supported by at least one of the intermediate beams, the number of the scaffolding boards being larger than the installing number of the intermediate beams by one,
the method of assembling the scaffolding device comprising:
a step of connecting other ends of a pair of longitudinal beams for expansion to each of the coup ling members disposed on one side of the frame body, the longitudinal beams each being attached with a coupling member for expansion at one end;
repeatedly performing, by the same number as the number of intermediate beams to be installed in the one frame body, a step of bridging an intermediate beam for expansion between the pair of longitudinal beams for expansion while bridging a scaffolding board for expansion between the pair of longitudinal beams for expansion while allowing the scaffolding board to be supported by at least the bridged intermediate beam for expansion;
a step of bridging a lateral beam for expansion between the coupling members for expansion; and
a step of bridging another scaffolding board for expansion between the longitudinal beams for expansion while allowing the scaffolding board for expansion to be supported by at least the lateral beam for expansion.

11. A method of assembling the scaffolding device according to claim 4, the method comprising:
a step of connecting each of the longitudinal beams to each of the front-side coupling member so as to be rotatable in the horizontal direction by inserting each of the first connecting pin into the hole of the first connecting portion and the front hole of the front-side coupling member in a state where the hole of the first connecting portion of each longitudinal beam and the front hole of the front-side coupling member face each other;
a step of connecting each of the end portions of the lateral beam to each of the depth-side coupling members so as to be rotatable in the horizontal direction by respectively pulling depth-side ends of the pair of longitudinal beams toward a front-side, by making holes of the second connecting portions of the lateral beam respectively face the right hole of the depth-side coupling member on the left side and the left hole of the depth-side coupling member on the right side, and by inserting the second connecting pins respectively through the left hole and the right hole into the holes of the respective second connecting portions; and
a step of rotating the pair of longitudinal beams in a horizontal direction with respect to the front-side coupling member so as to allow the longitudinal beams and the lateral beams to be disposed in parallel with each other.

12. (canceled)

13. (canceled)

14. (canceled)

15. A method of assembling the scaffolding device according to claim 5, the method comprising:
a step of connecting each of the longitudinal beams to each of the front-side coupling member so as to be rotatable in the horizontal direction by inserting each of the first connecting pin into the hole of the first connecting portion and the front hole of the front-side coupling member in a state where the hole of the first connecting portion of each longitudinal beam and the front hole of the front-side coupling member face each other;
a step of connecting each of the end portions of the lateral beam to each of the depth-side coupling members so as to be rotatable in the horizontal direction by respectively pulling depth-side ends of the pair of longitudinal beams toward a front-side, by making holes of the second connecting portions of the lateral beam respectively face the right hole of the depth-side coupling member on the left side and the left hole of the depth-side coupling member on the right side, and by inserting the second connecting pins respectively through the left hole and the right hole into the holes of the respective second connecting portions; and
a step of rotating the pair of longitudinal beams in a horizontal direction with respect to the front-side coupling member so as to allow the longitudinal beams and the lateral beams to be disposed in parallel with each other.

16. A method of assembling the scaffolding device according to claim 6, the method comprising:
a step of connecting each of the longitudinal beams to each of the front-side coupling member so as to be rotatable in the horizontal direction by inserting each of the first connecting pin into the hole of the first connecting portion and the front hole of the front-side coupling member in a state where the hole of the first connecting portion of each longitudinal beam and the front hole of the front-side coupling member face each other;
a step of connecting each of the end portions of the lateral beam to each of the depth-side coupling members so as to be rotatable in the horizontal direction by respectively pulling depth-side ends of the pair of longitudinal beams toward a front-side, by making holes of the second connecting portions of the lateral beam respectively face the right hole of the depth-side coupling member on the left side and the left hole of the depth-side coupling member on the right side, and by inserting the second connecting pins respectively through the left hole and the right hole into the holes of the respective second connecting portions; and
a step of rotating the pair of longitudinal beams in a horizontal direction with respect to the front-side coupling member so as to allow the longitudinal beams and the lateral beams to be disposed in parallel with each other.
